(19) United States
(12) Patent Application Publication
(10) Pub. No.: US 2025/0233812 A1
(43) Pub. Date: Jul. 17, 2025

(54) DATA CACHING METHOD AND APPARATUS, COMPUTER DEVICE, AND STORAGE MEDIUM

(71) Applicant: Tencent Technology (Shenzhen) Company Limited, Shenzhen (CN)

(72) Inventor: Bo WU, Shenzhen (CN)

(73) Assignee: Tencent Technology (Shenzhen) Company Limited, Shenzhen (CN)

(21) Appl. No.: 19/095,192

(22) Filed: Mar. 31, 2025

Related U.S. Application Data
(63) Continuation of application No. PCT/CN2024/073685, filed on Jan. 23, 2024.

(30) Foreign Application Priority Data
Mar. 10, 2023 (CN) 202310258748.0

(51) Int. Cl. H04L 43/062; H04L 43/16; H04L 67/568

(52) U.S. Cl. CPC H04L 43/062; H04L 43/16; H04L 67/568

(57) ABSTRACT

A data caching method includes acquiring a detection result for a device performance index of a terminal; determining whether the detection result satisfies a preset condition for initiating collaborative caching; determining, based on the detection result satisfying the preset condition, a network collaboration node for passing data between the terminal and a server, and generating a collaborative caching request indicating the network collaboration node is to cache target traffic data, wherein the target traffic data includes traffic data transmitted by the server to the terminal that is indicated in the collaborative caching request; transmitting the collaborative caching request to the network collaboration node; transmitting, based on a network data caching capacity of the terminal satisfying a preset storage condition, a data acquisition request to the network collaboration node; and receiving cached target traffic data transmitted by the network collaboration node in response to the data acquisition request.

### CROSS-REFERENCE TO RELATED APPLICATIONS

This application is a continuation application of International Application No. PCT/CN2024/073685 filed on Jan. 23, 2024, which claims priority to Chinese Patent Application No. 202310258748.0 filed with the China National Intellectual Property Administration on Mar. 10, 2023, the disclosures of each being incorporated by reference herein in their entireties.

### FIELD

The disclosure relates to the field of communication technologies, and to a data caching method and apparatus, a computer device, a storage medium, and a computer program product.

### BACKGROUND

With the development of communication technologies, the speed of data transmission is getting faster and faster, which allows a terminal to quickly acquire data requested to be accessed by a user from a server, thus greatly optimizing the response timeliness and the communication fluency.

In the traditional technologies, the server transmits the data requested to be accessed by the user to the terminal, and the terminal performs corresponding processing on the received data and presents the data to the user. However, device performance of the terminal varies greatly. For a terminal with poor device performance, the above method may cause serious packet loss, increase the data packet retransmission rate, and consume a large amount of communication resources.

### SUMMARY

According to an aspect of the disclosure, a data caching method, executed by a terminal, includes acquiring a detection result for a device performance index of the terminal; analyzing the detection result to determine whether the detection result satisfies a preset condition for initiating collaborative caching; determining, based on the detection result satisfying the preset condition, a network collaboration node through which data transmitted between the terminal and a server is to pass, and generating a collaborative caching request indicating the network collaboration node is to cache target traffic data, wherein the target traffic data includes traffic data transmitted by the server to the terminal that is indicated in the collaborative caching request; transmitting the collaborative caching request to the network collaboration node; transmitting, based on a network data caching capacity of the terminal satisfying a preset storage condition, a data acquisition request to the network collaboration node; and receiving cached target traffic data transmitted by the network collaboration node in response to the data acquisition request.

According to an aspect of the disclosure, a data caching apparatus includes, at least one memory configured to store computer program code; and at least one processor configured to read the program code and operate as instructed by the program code, the program code including first detection code configured to cause at least one of the at least one processor to acquire a detection result for a device performance index of a terminal; and analyze the detection result to determine whether the detection result satisfies a preset condition for initiating collaborative caching; and first generating code configured to cause at least one of the at least one processor to determine, based on the detection result satisfying the preset condition, a network collaboration node through which data transmitted between the terminal and a server is to pass, and generate a collaborative caching request indicating the network collaboration node is to cache target traffic data, wherein the target traffic data includes traffic data transmitted by the server to the terminal that is indicated in the collaborative caching request; first transmitting code configured to cause at least one of the at least one processor to transmit the collaborative caching request to the network collaboration node; second transmitting code configured to cause at least one of the at least one processor to transmit, based on a network data caching capacity of the terminal satisfying a preset storage condition, a data acquisition request to the network collaboration node; and first receiving code configured to cause at least one of the at least one processor to receive cached target traffic data transmitted by the network collaboration node in response to the data acquisition request.

According to an aspect of the disclosure, a non-transitory computer-readable storage medium, storing computer code which, when executed by at least one processor, causes the at least one processor to at least acquire a detection result for a device performance index of a terminal; analyze the detection result to determine whether the detection result satisfies a preset condition for initiating collaborative caching; determine, based on the detection result satisfying the preset condition, a network collaboration node through which data transmitted between the terminal and a server is to pass, and generate a collaborative caching request indicating the network collaboration node is to cache target traffic data, wherein the target traffic data includes traffic data transmitted by the server to the terminal that is indicated in the collaborative caching request; transmit the collaborative caching request to the network collaboration node; transmit, based on a network data caching capacity of the terminal satisfying a preset storage condition, a data acquisition request to the network collaboration node; and receive cached target traffic data transmitted by the network collaboration node in response to the data acquisition request.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an application environment of a data caching method in some embodiments.

FIG. 2 is a schematic flowchart of a data caching method in some embodiments.

FIG. 3 is a schematic flowchart of a data caching method in some embodiments.

FIG. 4 is a schematic diagram of storing data to a first data caching queue in some embodiments.

FIG. 5 is a schematic diagram of storing data to a second data caching queue in some embodiments.

FIG. 6 illustrates a schematic diagram that a network collaboration node delivers data to a terminal in some embodiments.

FIG. 7 is a schematic flowchart of a data caching method in some embodiments.

FIG. 8 is a schematic flowchart of a data caching method in some embodiments.

FIG. 9 is a structural block diagram of a data caching apparatus in some embodiments.

FIG. 10 is a structural block diagram of a data caching apparatus in some embodiments.

FIG. 11 is an internal structural diagram of a computer device in some embodiments.

FIG. 12 is an internal structural diagram of a computer device in some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

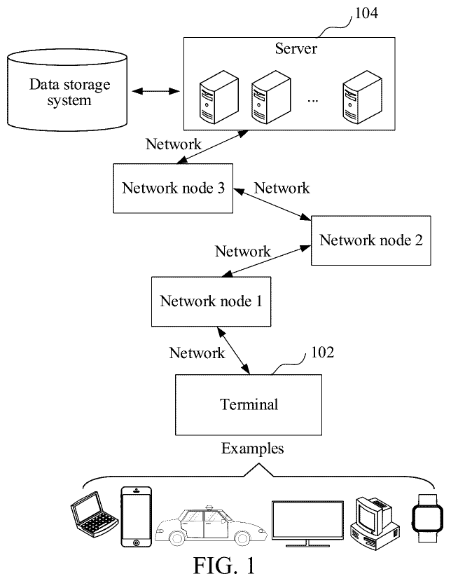

A data caching method provided by some embodiments may be applied to an application environment shown in FIG. 1. A terminal 102 communicates with a server 104 through a network. A data storage system may store data that the server 104 may process. The data storage system may be integrated on the server 104, or may be placed on the cloud or any other server. At least one network node is included between the terminal 102 and the server 104. The terminal 102 transmits data that may be transmitted to the server 104 to the server 104 through forwarding by the at least one network node. The server 104 transmits data that may be transmitted to the terminal 102 to the terminal 102 through forwarding by the at least one network node. Referring to FIG. 1, along a direction from the terminal 102 to the server 104, a network node 1, a network node 2, and a network node 3 are deployed sequentially. The data transmitted from the terminal 102 to the server 104 sequentially passes through the network node 1, the network node 2, and the network node 3, and finally reaches the server 104. The data transmitted from the server 104 to the terminal 102 sequentially passes through the network node 3, the network node 2, and the network node 1, and finally reaches the terminal 102. Any network node of the at least one network node may be used as a network collaboration node. Referring to FIG. 1, a previous hop node of the terminal 102 may be used as the network collaboration node, for example, the network node 1 may be used as the network collaboration node. In FIG. 1, only three network nodes are illustrated. The number of network nodes is not limited.

The terminal 102 may detect its own device performance index. In a case that a detection result satisfies a preset condition for initiating collaborative caching, a collaborative caching request is transmitted to the network collaboration node. The network collaboration node caches traffic data indicated by the collaborative caching request in the data transmitted by the server 104 to the terminal after receiving the collaborative caching request, and transmits the cached traffic data to the terminal 102 after receiving a data acquisition request transmitted by the terminal 102.

The terminal 102 may be, but is not limited to, various personal computers, laptops, smartphones, tablet computers, Internet of Things (IoT) devices, and portable wearable devices. The IoT devices may include smart speakers, smart TVs, smart air conditioners, smart in-vehicle devices, and the like. The portable wearable devices may be smart watches, smart bracelets, head-mounted devices, and the like. The terminal 102 may also be a camera, a printer, a microphone, a robotic arm in an industrial network, an automobile, or various internal terminal devices in the automobile, which has a network communication function. The server 104 may be an independent physical server, a server cluster or a distributed system composed of multiple physical servers, or a cloud server that provides cloud services, cloud databases, cloud computing, cloud functions, cloud storage, network services, cloud communications, middleware services, domain name services, security services, CDN, and cloud computing servers for big data and artificial intelligence platforms. The terminal may be, but is not limited to, a smartphone, a tablet computer, a laptop, a desktop computer, a smart speaker, a smart watch, or the like. The terminal and the server may be connected directly or indirectly through wired or wireless communication, which is not limited. The network nodes may be, but are not limited to, home routers, home switches, home firewalls, routers in carrier networks, switches in carrier networks, firewalls in carrier networks, servers in carrier networks, and other network devices with network storage and forwarding functions.

Cloud technology refers to a hosting technology that unifies hardware, software, networks, and other resources within a wide area network or local area network to achieve data computation, storage, processing, and sharing. Cloud technology is a term for network technology, information technology, integration technology, management platform technology, application technology and the like based on the application of cloud computing business models. It can form a resource pool, which can be used, thus achieving flexibility and convenience. Cloud computing technology will become an important support. Background services of technical network systems may use a large amount of computing and storage resources, such as video websites, image websites, and various portal websites. With the rapid development and application of the Internet industry, each thing may have its own identification mark in the future, which may be transmitted to a background system for logical processing. Data at different levels will be processed separately. All kinds of industry data may use strong system backing support, which can only be achieved through cloud computing.

Data requested to be accessed by a user may be stored through cloud storage. Cloud storage is a new concept that extends and develops from the concept of cloud computing. Distributed cloud storage system (hereinafter referred to as storage system) refers to a storage system that combines a large number of different types of storage devices (the storage devices are also known as storage nodes) in the network through cluster application, grid technology and distributed storage file systems to work together through application software or application interfaces to provide data storage and service access functions to the outside world. At present, a storage method for the storage system is as follows: create logical volumes, where a physical storage space is assigned to each logical volume when creating the logical volume, and the physical storage space may be composed of disks from a storage device or multiple storage devices. A client stores data on certain logical volume, that is, stores the data on a file system. The file system divides the data into multiple parts, each part is an object, and the object not only contains data but also contains additional information such as data identification (ID, ID entity). The file system writes each object separately to the physical storage space of the logical volume, and records storage location information of each object. When the client requests to access to the data, the file system can allow the client to access the data according to the storage location information of each object. A process that the storage system assigns the physical storage spaces to the logical volumes is as follows: according to a capacity estimate of objects stored on the logical volumes (the estimated capacity often has a large margin relative to an actual capacity of objects to be stored) and grouping of Redundant Array of Independent Disks (RAIDs), the physical storage spaces are pre-divided into stripes, and a logical volume may be understood as a stripe, thus assigning the physical storage spaces to the logical volumes.

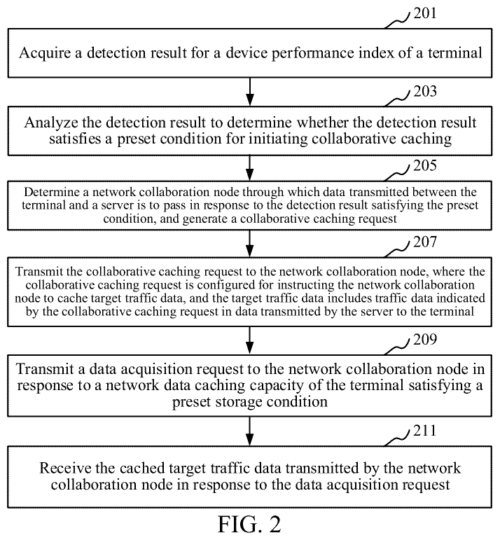

In some embodiments, as shown in FIG. 2, a data caching method is provided. Description is made by taking the method being applied to the terminal in FIG. 1 as an example. The method includes the following operations:

Operation 201: Acquire a detection result for a device performance index of the terminal.

Operation 203: Analyze the detection result to determine whether the detection result satisfies a preset condition for initiating collaborative caching.

Operation 205: Determine a network collaboration node through which data transmitted between the terminal and a server may pass in response to the detection result satisfying the preset condition, and generate a collaborative caching request.

Operation 207: Transmit the collaborative caching request to the network collaboration node, where the collaborative caching request is configured for instructing the network collaboration node to cache target traffic data, and the target traffic data includes traffic data indicated by the collaborative caching request in data transmitted by the server to the terminal.

Operation 209: Transmit a data acquisition request to the network collaboration node in response to a network data caching capacity of the terminal satisfying a preset storage condition.

Operation 211: Receive the cached target traffic data transmitted by the network collaboration node in response to the data acquisition request.

The terminal may detect the device performance index of the terminal to obtain the detection result. In a case that the detection result satisfies the preset condition for initiating collaborative caching, the collaborative caching request is generated based on the detection result.

The device performance index of the terminal may be information that can reflect the device performance. The device performance index of the terminal may include: at least one of device configuration of the terminal or performance of the terminal. The device configuration of the terminal may include at least one of model of a processor used by the terminal, internal memory configuration, and storage configuration. The performance of the terminal may include: at least one of a processor utilization rate, a remaining internal memory capacity, and a remaining storage space.

In some embodiments, the device performance index of the terminal may be detected to obtain the detection result. In a case that the detected device performance index indicates that the performance of the terminal is relatively poor, it is determined that the detection result satisfies the preset condition for initiating collaborative caching, and the collaborative caching request is generated.

The detection on the device performance index may be real-time detection, regular detection, periodic detection, or detection carried out according to a preset detection rule. However, the disclosure is not limited thereto. Regular detection may refer to detection on dates or at time points, while periodic detection refers to detection every certain period. The preset detection rule refers to detection carried out according to the preset rule except regular detection and periodic detection, such as detection carried out when certain specified events occur, for example, when a terminal load reaches a preset load level.

A device performance threshold may be preset for the device performance index, and a performance range corresponding to relatively poor performance may be determined based on the performance threshold. When the detected device performance index is within the performance range corresponding to relatively poor performance, it is determined that the performance of the terminal is relatively poor. It is determined that the detection result satisfies the preset condition for initiating collaborative caching, and the collaborative caching request is further generated based on the detection result.

In a case that the device performance index of the terminal is the device configuration of the terminal, and the device configuration of the terminal includes the model of the processor used by the terminal, the internal memory configuration, and the storage configuration, the model of the processor used by the terminal is compared with a preset model, the internal memory configuration of the terminal is compared with a preset internal memory configuration, and the storage configuration of the terminal is compared with a preset storage configuration. In a case that the model of the processor used by the terminal is poorer than the preset model, the internal memory configuration of the terminal is poorer than the preset internal memory configuration, or the storage configuration of the terminal is poorer than the preset storage configuration, it is determined that the performance of the terminal is relatively poor.

In a case that the device performance index of the terminal is the performance of the terminal, and the performance of the terminal includes the processor utilization rate, the remaining internal memory capacity, and the remaining storage space, the detection result for the processor utilization rate of the terminal is compared with a preset utilization rate threshold, the remaining internal memory capacity of the terminal is compared with a preset internal memory capacity threshold, and the remaining storage space of the terminal is compared with a preset space threshold. In a case that the processor utilization rate of the terminal is greater than the preset utilization rate threshold, the remaining internal memory capacity of the terminal is less than the preset internal memory capacity threshold, or the remaining storage space of the terminal is less than the preset space threshold, it is determined that the performance of the terminal is relatively poor.

In some embodiments, in a case that the detection result satisfies the preset condition for initiating collaborative caching, a collaborative caching type may be determined based on the detection result; and the collaborative caching request is generated based on the collaborative caching type.

In a case that the performance of the terminal is relatively poor, the terminal may be running under high load or overload. In a case that the detection result indicates that the terminal is running under overload, full traffic caching is used as the collaborative caching type, and the collaborative caching request is generated based on a collaborative caching type field value corresponding to full traffic caching and network configuration information of the terminal. In a case that the detection result indicates that the terminal is running under high load, partial traffic caching is used as the collaborative caching type, and a traffic identifier for media data under processing by the terminal is acquired; and the collaborative caching request is generated based on a collaborative caching type field value corresponding to partial traffic caching, the traffic identifier, and the network configuration information of the terminal.

The network configuration information of the terminal may include an Internet Protocol address (IP address), and may also include a port number, and the like. However, the disclosure is not limited thereto.

The network collaboration node is an intermediate node through which data transmitted between the terminal and the server may pass. The target traffic data includes: traffic data indicated by the collaborative caching request in data transmitted by the server to the terminal. As for the traffic data cached by the network collaboration node, the network collaboration node transmits the cached traffic data to the terminal after receiving the data acquisition request transmitted by the terminal. The data acquisition request is transmitted by the terminal in a case that the network data caching capacity of the terminal satisfies the preset storage condition.

The network collaboration node may be pre-configured, and the terminal may determine the network collaboration node through which the data transmitted between the terminal and the server may pass based on the pre-configured information. The network collaboration node may be selected from multiple network collaboration nodes, either randomly or by selecting the one with the lowest load, selecting the one with the highest network speed, or selecting according to other conditions. The traffic data is to statistically collect data communicated by the terminal through a communication network. The communication network may statistically collect a data volume of data communicated by the terminal through the network and constrain the data volume, for example, a total data volume of data communicated through the communication network is constrained. An operator of the communication network may also charge fees according to the actual data volume of data communicated by a terminal user through the communication network.

After generating the collaborative caching request, the terminal transmits the collaborative caching request to the network collaboration node. After receiving the collaborative caching request, the network collaboration node detects its own device performance index and determines whether to participate in collaborative caching initiated by the terminal based on the detection result.

In a case that it is determined to participate in collaborative caching initiated by the terminal, a collaboration request confirmation message is generated based on a field value corresponding to collaborative caching participation and is transmitted to the terminal. In a case that it is determined to refuse to participate in collaborative caching initiated by the terminal, a collaboration request confirmation message is generated based on a field value corresponding to collaborative caching participation refusal and is transmitted to the terminal.

A performance threshold for whether to participate in collaborative caching may be preset. Based on the performance threshold, a performance range corresponding to that the network collaboration node can participate in collaborative caching and a performance range corresponding to that the network collaboration node cannot participate in collaborative caching are determined. When the device performance index of the network collaboration node is within the performance range corresponding to that the network collaboration node can participate in collaborative caching, it is determined to participate in collaborative caching initiated by the terminal. When the device performance index of the network collaboration node is within the performance range corresponding to that the network collaboration node cannot participate in collaborative caching, it is determined to refuse to participate in collaborative caching initiated by the terminal.

In a case that it is determined that the network collaboration node participates in collaborative caching initiated by the terminal, information carried in the collaborative caching request may be locally stored as a set of data. A corresponding data caching queue is created for the collaborative caching request.

In some embodiments, in a case that the collaborative caching request carries the collaborative caching type field value corresponding to full traffic caching and the network configuration information of the terminal, a corresponding data caching queue is created for the network configuration information of the terminal.

In some embodiments, in a case that the collaborative caching request carries the collaborative caching type field value corresponding to partial traffic caching, the traffic identifier, and the network configuration information of the terminal, a corresponding data caching queue is created for the traffic identifier.

In some embodiments, after receiving a to-be-processed traffic message from the server, the network collaboration node extracts a destination address from the to-be-processed traffic message and matches an IP address in each set of locally stored data with the destination address. In a case that matching succeeds, it is determined that a terminal corresponding to the destination address initiates collaborative caching. In a case that matching fails, it is determined that the terminal corresponding to the destination address does not initiate collaborative caching, and the to-be-processed traffic message is directly forwarded to the terminal.

In a case that the terminal corresponding to the destination address extracted by the network collaboration node initiates collaborative caching, traffic data in the to-be-processed traffic message is used as target traffic data, a collaborative caching type is searched for in the successfully matched set of data, and the target traffic data is cached based on the searched collaborative caching type.

In some embodiments, in a case that the searched collaborative caching type is full traffic caching, the target traffic data is cached in a first data caching queue. The first data caching queue is a queue created by the network collaboration node for the network configuration information in the set of data. In a case that the searched collaborative caching type is partial traffic caching, a to-be-matched traffic identifier is determined based on the network configuration information in the to-be-processed traffic message. In a case that the to-be-matched traffic identifier matches with the traffic identifier in the set of data, the target traffic data is cached in a second data caching queue. The second data caching queue is a queue created by the network collaboration node for the traffic identifier in the set of data.

The network data caching capacity refers to an available capacity of a space on the terminal that can be available for caching network data. The preset storage condition refers to a preset condition that the network data caching capacity may satisfy, which may be a preset condition that the network data caching capacity configured for caching the traffic data when the terminal can process the traffic data in a normal working state is to satisfy.

The terminal may detect its own network data caching capacity in real time. When it is detected that its own network data caching capacity satisfies the preset storage condition, a data volume of to-be-acquired traffic data is determined based on the network data caching capacity, and the data acquisition request is generated based on the data volume and is transmitted to the network collaboration node.

In some embodiments, in a case that the collaborative caching type is full traffic caching, the terminal may generate the data acquisition request based on the network configuration information of the terminal and the data volume described above. In a case that the collaborative caching type is partial traffic caching, the terminal may generate the data acquisition request based on the traffic identifier in the collaborative caching request and the data volume described above.

The data volume may be the number of data packets of the to-be-acquired traffic data, or the size of a space occupied by the to-be-acquired traffic data. The data volume of the to-be-acquired traffic data may be 100 packets or 100 MB.

After receiving the data acquisition request, the network collaboration node may parse the data acquisition request, extract traffic data matching the data volume obtained by parsing from a target data caching queue, and transmit the extracted traffic data to the terminal. The target data caching queue is a data caching queue created in advance for the collaborative caching request.

In some embodiments, the terminal may detect its own device performance index. In a case that a detection result satisfies the preset condition for initiating collaborative caching, the collaborative caching request is transmitted to the network collaboration node. The network collaboration node caches traffic data indicated by the collaborative caching request in the data transmitted by the server to the terminal after receiving the collaborative caching request, and transmits the cached traffic data to the terminal after receiving the data acquisition request transmitted by the terminal. The terminal with relatively poor device performance suffers from serious packet loss in the data returned by the server, which may cause the server to retransmit lost data packets. The above mode that the network collaboration node assists the terminal with relatively poor device performance in caching data can reduce packet loss caused by poor device performance of the terminal, lower a data retransmission rate of the server, and avoid problems such as lagging and screen flickering caused by excessive processing load on the terminal with relatively poor device performance.

In some embodiments, the device performance index includes: at least one of a processor utilization rate and a remaining internal memory capacity. The method further includes: determine that the detection result satisfies the preset condition for initiating collaborative caching when at least one of a first preset condition and a second preset condition is satisfied. The first preset condition is that: a first preset relationship is maintained between a detection result for the processor utilization rate and a first preset utilization rate threshold for a duration exceeding a first duration threshold. The second preset condition is that: a second preset relationship is maintained between a detection result for the remaining internal memory capacity and a first preset internal memory capacity threshold for a duration exceeding a second duration threshold.

The first preset utilization rate threshold may be flexibly set according to actual situations. The first preset utilization rate threshold may be set to 90%. The first preset relationship may be that the processor utilization rate is greater than or equal to the first preset utilization rate threshold. The first duration threshold may also be flexibly set according to actual situations. The first duration threshold may be recorded in an instruction manual of the terminal for an owner of the terminal to view. The first duration threshold may be set to 5 s, 10 s, 30 s, 1 min, 2 min, and the like.

The first preset internal memory capacity threshold may be flexibly set according to actual situations. The first preset internal memory capacity threshold may be set to 2 G. The second preset relationship may be that the remaining internal memory capacity is less than or equal to the first preset internal memory capacity threshold. The second duration threshold may also be flexibly set according to actual situations. The second duration threshold may also be recorded in the instruction manual of the terminal for the owner of the terminal to view. The second duration threshold may be set to 5 s, 10 s, 30 s, 1 min, 2 min, and the like.

In some embodiments, when the processor utilization rate is greater than or equal to the first preset utilization rate threshold for a duration exceeding the first duration threshold, it indicates that the performance of the terminal is relatively poor, and it may be determined that the detection result satisfies the preset condition for initiating collaborative caching.

In some embodiments, when the remaining internal memory capacity is less than or equal to the first preset internal memory capacity threshold, it indicates that the performance of the terminal is relatively poor, and it may be determined that the detection result satisfies the preset condition for initiating collaborative caching. When the remaining internal memory capacity is less than or equal to the first preset internal memory capacity threshold for a duration exceeding the second duration threshold, it indicates the performance of the terminal is relatively poor, and it may be determined that the detection result satisfies the preset condition for initiating collaborative caching.

In some embodiments, when the processor utilization rate is greater than or equal to the first preset utilization rate threshold for a duration exceeding the first duration threshold and the remaining internal memory capacity is less than or equal to the first preset internal memory capacity threshold for a duration exceeding the second duration threshold, it indicates that the performance of the terminal is relatively poor, and it may be determined that the detection result satisfies the preset condition for initiating collaborative caching.

In some embodiments, when the first preset relationship is maintained between the detection result for the processor utilization rate and the first preset utilization rate threshold for a duration exceeding the first duration threshold; and/or when the second preset relationship is maintained between the remaining internal memory capacity and the first preset internal memory capacity threshold for a duration exceeding the second duration threshold, it is determined that the current performance of the terminal is relatively poor and the preset condition for initiating collaborative caching is satisfied, so that the network collaboration node can collaborate with the terminal to cache data, thus avoiding problems such as lagging and screen flickering caused by relatively poor device performance.

In some embodiments, the operation of generating the collaborative caching request includes: determine a collaborative caching type based on the detection result; and generate the collaborative caching request based on the collaborative caching type.

In some embodiments, in a case that the detection result satisfies the preset condition for initiating collaborative caching, a load level at which the processing load of the terminal is located may be determined based on the detection result, the collaborative caching type is determined based on the load level, and finally the collaborative caching request is generated based on the collaborative caching type.

A load threshold may be preset, and a performance range corresponding to overload and a performance range corresponding to high load are determined based on the load threshold. When the detected device performance index is within the performance range corresponding to overload, it is determined that the processing load of the terminal is in an overload state; and when the detected device performance index is within the performance range corresponding to high load, it is determined that the processing load of the terminal is in a high load state.

The preset load threshold includes a first load threshold set for the processor utilization rate, a second load threshold set for the remaining internal memory capacity, and a third load threshold set for the remaining storage space. The detection result for the processor utilization rate of the terminal is compared with the first load threshold, the remaining internal memory capacity of the terminal is compared with the second load threshold, and the remaining storage space of the terminal is compared with the third load threshold. In a case that the processor utilization rate of the terminal is greater than the first load threshold, the remaining internal memory capacity of the terminal is less than the second load threshold, and the remaining storage space of the terminal is less than the third load threshold, it is determined that the processing load of the terminal is in an overload state. In a case that the processor utilization rate of the terminal is greater than the first preset utilization rate threshold but less than the first load threshold, or the remaining internal memory capacity of the terminal is greater than the second load threshold but less than the first preset internal memory capacity threshold, or the remaining storage space of the terminal is greater than the third load threshold but less than the preset space threshold, it is determined that the processing load of the terminal is in a high load state.

In some embodiments, in a case that it is determined that the processing load of the terminal is in the overload state, full traffic caching is used as the collaborative caching type, and the collaborative caching request is generated based on the collaborative caching type field value corresponding to full traffic caching and the network configuration information of the terminal.

In some embodiments, in a case that it is determined that the processing load of the terminal is in the high load state, partial traffic caching is used as the collaborative caching type, and the traffic identifier for the media data under processing by the terminal is acquired; and the collaborative caching request is generated based on the collaborative caching type field value corresponding to partial traffic caching, the traffic identifier, and the network configuration information of the terminal.

In some embodiments, the collaborative caching type is determined based on the detection result; and the collaborative caching request is generated based on the collaborative caching type. In a case that the device performance of the terminal is very poor (overload), the network collaboration node may assist the terminal in caching all to-be-received data; and in a case that the device performance of the terminal is slightly poor (high load), the network collaboration node may assist the terminal in caching some of to-be-received data. The provision of flexible caching mechanisms allows the terminal to choose a caching mechanism to cache own data based on its own device performance, thus improving the adaptability of the caching mode to the device performance, and improving the service experience problems such as lagging and screen flickering caused by poor device performance of the terminal.

In some embodiments, the operation of generating the collaborative caching request based on the collaborative caching type includes: in a case that the collaborative caching type is full traffic caching, generate the collaborative caching request based on the collaborative caching type field value corresponding to full traffic caching and the network configuration information of the terminal.

A collaborative caching type field may occupy 2 bits, and the collaborative caching type field value corresponding to full traffic caching may be binary 00. The collaborative caching type field may be expressed as Type_coll. When the value of Type_coll is 00, it represents that the collaborative caching type is full traffic caching. Full traffic caching may be understood as that the terminal requests the network collaboration node to assist the terminal in caching all to-be-received data.

The network configuration information of the terminal may include an IP address of the terminal, and may also include a port number, and the like. However, the disclosure is not limited thereto.

In some embodiments, the collaborative caching request may be expressed by the following formula:

Pkt_coll={Type_coll, Info_client}

where Pkt_coll represents the collaborative caching request, and Type_coll represents the collaborative caching type. Info_client represents the network configuration information of the terminal, and the value of Type_coll is 00 in a case that the collaborative caching type is full traffic caching.

In some embodiments, in a case that the collaborative caching type is full traffic caching, the collaborative caching request is generated based on the collaborative caching type field value corresponding to full traffic caching and the network configuration information of the terminal. The terminal may transmit the collaborative caching request to the network collaboration node, and the network collaboration node may cache all data to be received by the terminal based on the collaborative caching request, thus improving the service experience problems such as lagging and screen flickering caused by poor device performance of the terminal.

In some embodiments, the data caching method further includes: determine the data volume of to-be-acquired traffic data based on the network data caching capacity in a case that it is detected that the network data caching capacity of the terminal satisfies the preset storage condition; generate the data acquisition request based on the network configuration information of the terminal and the data volume; transmit the data acquisition request to the network collaboration node, where the data acquisition request is configured for instructing the network collaboration node to parse the received data acquisition request, search for a data caching queue corresponding to the network configuration information obtained by parsing, and extract traffic data matching a data volume obtained by parsing from the searched data caching queue; and receiving traffic data returned by the network collaboration node.

A condition for triggering the terminal to acquire data from the network collaboration node may be preset. The condition may be the preset storage condition. The preset storage condition may include a storage space threshold.

The terminal may detect its own network data caching capacity. In a case that the network data caching capacity is greater than the storage space threshold, it is determined that the network data caching capacity satisfies the preset storage condition. The detection on the network data caching capacity of the terminal may be real-time detection, regular detection, periodic detection, or detection carried out according to a preset detection rule. However, the disclosure is not limited thereto.

The data volume of the to-be-acquired traffic data may be the number of data packets of the to-be-acquired traffic data, or the size of a space occupied by the to-be-acquired traffic data.

In some embodiments, the terminal may determine the size of an available caching space based on the network data caching capacity, determine the number of data packets that can be placed in the available caching space based on the size of the available caching space, and use this number as the data volume of the to-be-acquired traffic data.

In some embodiments, the terminal may determine the size of the available caching space based on the network data caching capacity, and use the size of the available caching space as the data volume of the to-be-acquired traffic data.

The data acquisition request carries the network configuration information of the terminal and the data volume. The network collaboration node parses the received data acquisition request, searches for a data caching queue corresponding to the network configuration information obtained by parsing, extracts traffic data matching the data volume obtained by parsing from the searched data caching queue, and transmits the extracted traffic data to the terminal.

In some embodiments, in a case that the data volume carried in the data acquisition request is the number of data packets, the network collaboration node extracts traffic data matching the number of data packets from the searched data caching queue, and transmits the extracted traffic data to the terminal.

The data acquisition request carries a data volume of 100 data packets, and the network collaboration node extracts 100 data packets from the searched data caching queue, and transmits the extracted traffic data to the terminal.

In some embodiments, in a case that the data volume carried in the data acquisition request is the size of the occupied space, the network collaboration node extracts traffic data matching the size of the occupied space from the searched data caching queue, and transmits the extracted traffic data to the terminal.

The data acquisition request carries a data volume of 100 MB, and the network collaboration node extracts 100 MB traffic data from the searched data caching queue, and transmits the extracted traffic data to the terminal.

In some embodiments, in a case that the collaborative caching type is full traffic caching, the terminal transmits the collaborative caching request to the network collaboration node, detects its own network data caching capacity, determines the data volume of to-be-acquired traffic data based on the network data caching capacity in a case that the network data caching capacity satisfies the preset storage condition, generates the data acquisition request based on the network configuration information of the terminal and the data volume, and transmits the data acquisition request to the network collaboration node; the network collaboration node parses the received data acquisition request after receiving the data acquisition request, searches for a data caching queue corresponding to the network configuration information obtained by parsing, extracts traffic data matching a data volume obtained by parsing from the searched data caching queue, and transmits the extracted traffic data to the terminal. In a case that the device performance of the terminal is very poor, the network collaboration node may assist the terminal in caching all to-be-received data; and when the network data caching capacity of the terminal can accommodate new traffic data, it may request the network collaboration node to deliver the data, thus alleviating the processing pressure of the terminal and improving the service experience problems such as lagging, screen flickering, and mosaic.

In some embodiments, the data caching method further includes: generate a collaboration cancellation request based on a collaborative caching type field value corresponding to collaborative caching cancellation and the network configuration information of the terminal in a case that it is detected that the device performance index of the terminal satisfies a condition for canceling collaborative caching; transmit the collaboration cancellation request to the network collaboration node, where the collaboration cancellation request is configured for instructing the network collaboration node to parse the received collaboration cancellation request and delete a data caching queue corresponding to the network configuration information obtained by parsing; and receive a collaborative caching cancellation message transmitted by the network collaboration node.

A corresponding device performance threshold may be preset for a scenario of collaborative caching cancellation, a device performance range may be determined based on the device performance threshold, and in a case that the detected device performance index is within the device performance range, it may be determined that the device performance index satisfies the condition for canceling collaborative caching. In a case that the terminal detects that the media data under processing is closed, it may also be determined that the device performance index satisfies the condition for canceling collaborative caching. In a case that the terminal is currently playing certain video and a viewer closes the video, it may be determined that the device performance index satisfies the condition for canceling collaborative caching.

A collaborative caching type field value corresponding to collaborative caching cancellation may be 11. The network configuration information of the terminal may include an IP address of the terminal, and may also include a port number, and the like.

In some embodiments, the collaboration cancellation request may be expressed by the following formula:

$$Pkt\_coll \_cancle = \{ Type\_coll , Info\_client \}$$

where Pkt_coll_cancle represents the collaboration cancellation request, and

Type_coll represents the collaborative caching type. Info_client represents the network configuration information of the terminal, and the collaborative caching type field value may be 11.

In some embodiments, after receiving the collaboration cancellation request, the network collaboration node parses the received collaboration cancellation request, searches for a data caching queue corresponding to the network configuration information obtained by parsing, and deletes the data caching queue.

In some embodiments, after deleting the data caching queue, the network collaboration node may transmit the collaborative caching cancellation message to the terminal, and subsequently the network collaboration node will no longer cache traffic data for the terminal. The collaborative caching cancellation message may be expressed as Pkt_coll_cancle_ack.

In some embodiments, in a case that it is detected that the device performance index satisfies the condition for canceling collaborative caching, the terminal generates the collaboration cancellation request based on the collaborative caching type field value corresponding to collaborative caching cancellation and the network configuration information of the terminal, and transmits the collaboration cancellation request to the network collaboration node; the network collaboration node parses the received collaboration cancellation request and deletes the data caching queue corresponding to the network configuration information obtained by parsing; and subsequently the network collaboration node will no longer cache traffic data for the terminal. The terminal with improved device performance can exit the collaborative caching mechanism, thus reducing the caching pressure of the network collaboration node.

In some embodiments, the operation of generating the collaborative caching request based on the collaborative caching type includes: acquire the traffic identifier for the media data under processing by the terminal in a case that the collaborative caching type is partial traffic caching; and generate the collaborative caching request based on the collaborative caching type field value corresponding to partial traffic caching, the traffic identifier, and the network configuration information of the terminal.

A collaborative caching type field may occupy 2 bits, and the collaborative caching type field value corresponding to partial traffic caching may be binary 01. The collaborative caching type field may be expressed as Type_coll. When the value of Type_coll is 01, it represents that the collaborative caching type is partial traffic caching. Partial traffic caching may be understood as that the terminal requests the network collaboration node to assist the terminal in caching the media data under processing.

The media data under processing by the terminal may be text, images, videos, audio, and the like. However, the disclosure is not limited thereto. For the convenience of description, the media data under processing by the terminal is referred to as target media data.

In some embodiments, in a case that the network protocol between the terminal and the server is Transmission Control Protocol (TCP) or User Datagram Protocol (UDP), the terminal may acquire the IP address of the terminal, the port number of a port for processing the target media data on the terminal, the IP address of the server, and the port number of a port for processing the target media data on the server. A traffic identifier for the target media data is generated based on the IP address of the terminal, the port number of the port for processing the target media data on the terminal, the IP address of the server, the port number of the port for processing the target media data on the server, and the network protocol between the terminal and the server.

In some embodiments, in a case that the network protocol between the terminal and the server is quick udp Internet connection (QUIK), the traffic identifier for the target media data may be determined based on a connection identifier determined through negotiation between the terminal and the server for transmitting the target media data.

In some embodiments, the collaborative caching request may be expressed by the following formula:

$$Pkt\_coll = \{ Type\_coll , flowID , Info\_client \}$$

where Pkt_coll represents the collaborative caching request, and Type_coll represents the collaborative caching type. flowID represents the traffic identifier for the media data under processing by the terminal, Info_client represents the network configuration information of the terminal, and the value of Type_coll is 01 in a case that the collaborative caching type is full traffic caching.

In some embodiments, in a case that the collaborative caching type is partial traffic caching, the traffic identifier for the media data under processing by the terminal is acquired; and the collaborative caching request is generated based on the collaborative caching type field value corresponding to partial traffic caching, the traffic identifier, and the network configuration information of the terminal. The terminal may transmit the collaborative caching request to the network collaboration node, and the network collaboration node may cache traffic data corresponding to the traffic identifier carried in the collaborative caching request, thus improving the service experience problems such as lagging and screen flickering caused by poor device performance of the terminal.

In some embodiments, the operation of acquiring the traffic identifier for the media data under processing by the terminal includes: acquire the network configuration information of the terminal, network configuration information of the server, and a network protocol for communication between the terminal and the server; concatenate the network configuration information of the terminal, the network configuration information of the server, and the network protocol to obtain a concatenation result; and encrypt the concatenation result and use an encrypted result as the traffic identifier for the media data under processing by the terminal.

For the convenience of description, the media data under processing by the terminal is referred to as target media data. The network configuration information of the terminal includes: the IP address of the terminal and the port number of a port for processing the target media data on the terminal. The network configuration information of the server includes: the IP address of the server and the port number of a port for processing the target media data on the server.

The network protocol may be Transmission Control Protocol (TCP) or User Datagram Protocol (UDP), which is not limited.

A hash operation may be performed on the concatenation result to encrypt the concatenation result, and a hash operation result may be used as the traffic identifier for the media data under processing by the terminal.

In some embodiments, the traffic identifier for the target media data may be determined through the following formula:

$$FlowID = Hash ( src ‖ dst ‖ sport ‖ dport ‖ prot )$$

where FlowID is the traffic identifier for the target media data, src is the IP address of the server, dst is the IP address of the terminal, sport is the port number of the port for processing the target media data on the server, dport is the port number of the port for processing the target media data on the terminal, and prot is the network protocol between the terminal and the server. The symbol “∥” represents a character string concatenation operation. src∥dst∥sport∥dport∥prot is the concatenation result obtained by concatenating the network configuration information of the terminal, the network configuration information of the server, and the network protocol. Hash ( ) function represents the hash operation.

In some embodiments, the network configuration information of the terminal, the network configuration information of the server, and the network protocol for communication between the terminal and the server are acquired; the network configuration information of the terminal, the network configuration information of the server, and the network protocol are concatenated to obtain the concatenation result; and the concatenation result is encrypted and an encrypted result is used as the traffic identifier for the media data under processing by the terminal. The traffic identifier may be carried in the collaborative caching request to be transmitted to the network collaboration node, so that the network collaboration node caches the traffic data corresponding to the traffic identifier, thus improving the service experience problems such as lagging and screen flickering caused by poor device performance of the terminal.

In some embodiments, the operation of acquiring the traffic identifier for the media data under processing by the terminal includes: use a connection identifier determined through negotiation between the terminal and the server for transmitting the media data under processing by the terminal as the traffic identifier for the media data under processing by the terminal.

After detecting a trigger operation on certain media data, the terminal may establish a connection for transmitting the media data through negotiation with the server, and subsequently the server may transmit the corresponding media data through the connection. The connection established between the terminal and the server corresponds to the media data on a one-to-one basis, and a connection identifier may be configured for distinguishing the media data.

In some embodiments, in a case that the collaborative caching type is partial traffic caching, the connection identifier determined through negotiation between the terminal and the server for transmitting the media data under processing by the terminal may be queried, and the queried connection identifier may be used as the traffic identifier for the media data under processing by the terminal.

In a case that the media data under processing by the terminal is a video and the collaborative caching type is partial traffic caching, a connection identifier determined through negotiation between the terminal and the server for transmitting the video may be queried, and the queried connection identifier may be used as a traffic identifier for the video.

In some embodiments above, the connection identifier determined through negotiation between the terminal and the server for transmitting the media data under processing by the terminal is used as the traffic identifier for the media data under processing by the terminal. The traffic identifier may be carried in the collaborative caching request to be transmitted to the network collaboration node, so that the network collaboration node caches the traffic data corresponding to the traffic identifier, thus improving the service experience problems such as lagging and screen flickering caused by poor device performance of the terminal.

In some embodiments, the data caching method further includes: determine the data volume of to-be-acquired traffic data based on the network data caching capacity in a case that it is detected that the network data caching capacity of the terminal satisfies the preset storage condition; generate the data acquisition request based on the traffic identifier and the data volume; transmit the data acquisition request to the network collaboration node, where the data acquisition request is configured for instructing the network collaboration node to parse the received data acquisition request, search for a data caching queue corresponding to the traffic identifier obtained by parsing, and extract traffic data matching the data volume obtained by parsing from the searched data caching queue; and receive traffic data returned by the network collaboration node.

Similar to full traffic caching, a condition for triggering the terminal to acquire data from the network collaboration node may be preset. The condition may be the preset storage condition. The preset storage condition may include a storage space threshold.

Similar to full traffic caching, the terminal may detect its own network data caching capacity. In a case that the network data caching capacity is greater than the storage space threshold, it is determined that the network data caching capacity satisfies the preset storage condition. The detection on the network data caching capacity of the terminal may be real-time detection, regular detection, periodic detection, or detection carried out according to a preset detection rule. However, the disclosure is not limited thereto.

Similar to full traffic caching, the data volume of the to-be-acquired traffic data may be the number of data packets of the to-be-acquired traffic data, or the size of a space occupied by the to-be-acquired traffic data.

In some embodiments, the terminal may determine the size of an available caching space based on the network data caching capacity, determine the number of data packets that can be placed in the available caching space based on the size of the available caching space, and use this number as the data volume of the to-be-acquired traffic data. The terminal may determine the size of the available caching space based on the network data caching capacity, and use the size of the available caching space as the data volume of the to-be-acquired traffic data.

The data acquisition request carries the network configuration information of the terminal and the data volume. The network collaboration node parses the received data acquisition request, searches for a data caching queue corresponding to the traffic identifier obtained by parsing, extracts traffic data matching the data volume obtained by parsing from the searched data caching queue, and transmits the extracted traffic data to the terminal. The process that the network collaboration node extracts data from the searched data caching queue is similar to that in full traffic caching.

In some embodiments, in a case that the collaborative caching type is partial traffic caching, the terminal transmits a collaborative caching request to the network collaboration node, detects its own network data caching capacity, determines the data volume of to-be-acquired traffic data based on the network data caching capacity in a case that the network data caching capacity satisfies the preset storage condition, generates the data acquisition request based on the traffic identifier and the data volume, and transmits the data acquisition request to the network collaboration node; the network collaboration node parses the received data acquisition request after receiving the data acquisition request, searches for a data caching queue corresponding to the traffic identifier obtained by parsing, extracts traffic data matching the data volume obtained by parsing from the searched data caching queue, and transmits the extracted traffic data to the terminal. In a case that the device performance of the terminal is slightly poor, the network collaboration node may assist the terminal in caching data traffic corresponding to the media data under processing; when the network data caching capacity of the terminal can accommodate new traffic data, it may request the network collaboration node to deliver the corresponding data, thus alleviating the processing pressure of the terminal and improving the service experience problems such as lagging, screen flickering, and mosaic.

In some embodiments, the data caching method further includes: generate the collaboration cancellation request based on a type field value corresponding to collaborative caching cancellation and the traffic identifier in a case that it is detected that the device performance index of the terminal satisfies the condition for canceling collaborative caching; transmit the collaboration cancellation request to the network collaboration node, where the collaboration cancellation request is configured for instructing the network collaboration node to parse the received collaboration cancellation request and delete a data caching queue corresponding to the traffic identifier obtained by parsing; and receive the collaborative caching cancellation message transmitted by the network collaboration node.

Similar to full traffic caching, a corresponding device performance threshold may be preset for a scenario of collaborative caching cancellation, a device performance range may be determined based on the device performance threshold, and in a case that the detected device performance index is within the device performance range, it may be determined that the device performance index satisfies the condition for canceling collaborative caching. In a case that the terminal detects that the media data under processing is closed, it may also be determined that the device performance index satisfies the condition for canceling collaborative caching. In a case that the terminal is currently playing certain video and a viewer closes the video, it may be determined that the device performance index satisfies the condition for canceling collaborative caching.

In some embodiments, the collaboration cancellation request may be expressed by the following formula:

$$Pkt\_coll \_cancle = \{ Type\_coll , FlowID , Info\_client \}$$

where Pkt_coll_cancle represents the collaboration cancellation request, and Type_coll represents the collaborative caching type. FlowID represents the traffic identifier for the media data under processing by the terminal, Info_client represents the network configuration information of the terminal, and the collaborative caching type field value may be 11.

In some embodiments, after receiving the collaboration cancellation request, the network collaboration node parses the received collaboration cancellation request, searches for a data caching queue corresponding to the traffic identifier obtained by parsing, and deletes the data caching queue.

In some embodiments, after deleting the data caching queue, the network collaboration node may transmit the collaborative caching cancellation message to the terminal, and subsequently the network collaboration node will no longer cache traffic data for the terminal. The collaborative caching cancellation message may be expressed as Pkt_coll_cancle_ack.

In some embodiments, in a case that it is detected that the device performance index satisfies the condition for canceling collaborative caching, the terminal generates the collaboration cancellation request based on the collaborative caching type field value corresponding to collaborative caching cancellation and the traffic identifier for the media data under processing by the terminal the terminal, and transmits the collaboration cancellation request to the network collaboration node; the network collaboration node parses the received collaboration cancellation request and deletes the data caching queue corresponding to the traffic identifier obtained by parsing; and subsequently the network collaboration node will no longer cache corresponding traffic data for the terminal. The terminal with improved device performance can exit the collaborative caching mechanism, thus reducing the caching pressure of the network collaboration node.

In some embodiments, after the operation of transmitting the collaborative caching request to the network collaboration node, the method further includes: receive a collaboration request confirmation message transmitted by the network collaboration node, where the collaboration request confirmation message is configured for indicating whether the network collaboration node participates in collaborative caching, and the collaboration request confirmation message is generated by the network collaboration node based on its own device performance index.

After receiving the collaborative caching request transmitted by the terminal, the network collaboration node detects its own device performance index and determines whether to participate in collaborative caching initiated by the terminal based on the detection result.

In some embodiments, in a case that the network collaboration node determines to participate in collaborative caching initiated by the terminal, the collaboration request confirmation message is generated based on a field value corresponding to collaborative caching participation and is transmitted to the terminal. In a case that the network collaboration node determines to refuse to participate in collaborative caching initiated by the terminal, the collaboration request confirmation message is generated based on a field value corresponding to collaborative caching participation refusal and is transmitted to the terminal.

A target field for indicating whether a network node participates in collaborative caching may be set in the collaboration request confirmation message. In a case that the network collaboration node determines to participate in collaborative caching initiated by the terminal, the value of the target field may be determined as a first preset value; and in a case that the network collaboration node determines to refuse to participate in collaborative caching initiated by the terminal, the value of the target field may be determined as a second preset value.

The target field may be expressed as Join_coll, the first preset value may be 1, and the second preset value may be 0, which are not limited.

After receiving the collaboration request confirmation message, the terminal may confirm whether the network collaboration node participates in collaborative caching based on the target field in the collaboration request confirmation message.

In some embodiments, the network collaboration node detects its own device performance index after receiving the collaborative caching request transmitted by the terminal, participates in collaborative caching initiated by the terminal in a case that its own performance allows, and does not participate in collaborative caching initiated by the terminal in a case that its own performance does not allow. This negotiation mechanism provides flexible selectivity for the network collaboration node to participate in collaborative caching, thus avoiding the problem of high processing load caused by participation in collaborative caching when its own performance is relatively poor.

In some embodiments, the device performance index includes: at least one of the processor utilization rate and the remaining internal memory capacity. The data caching method provided further includes: determine that the detection result satisfies the condition for canceling collaborative caching when at least one of a third condition and a fourth condition is satisfied. The third condition is that: a third preset relationship is satisfied between the detection result for the processor utilization rate and a second preset utilization rate threshold. The fourth condition is that: a fourth preset relationship is satisfied between the detection result for the remaining internal memory capacity and a second preset internal memory capacity threshold.

The second preset utilization rate threshold may be flexibly set according to actual situations. The second preset utilization rate threshold may be set to 70%. The third preset relationship may be that the processor utilization rate is greater than or equal to the second preset utilization rate threshold.

The second preset internal memory capacity threshold may be flexibly set according to actual situations. The second preset internal memory capacity threshold may be set to 1 G. The fourth preset relationship may be that the remaining internal memory capacity is greater than or equal to the second preset internal memory capacity threshold.

In some embodiments, when the processor utilization rate is less than or equal to the second preset utilization rate threshold, it indicates that the performance of the terminal is improved, and it may be determined that the detection result satisfies the condition for canceling collaborative caching.

In some embodiments, when the remaining internal memory capacity is greater than or equal to the second preset internal memory capacity threshold, it indicates that the performance of the terminal is improved, and it may be determined that the detection result satisfies the condition for canceling collaborative caching.

In some embodiments, when the processor utilization rate is less than or equal to the second preset utilization rate threshold and the remaining internal memory capacity is greater than or equal to the second preset internal memory capacity threshold, it indicates that the performance of the terminal is improved, and it may be determined that the detection result satisfies the condition for canceling collaborative caching.

In some embodiments, when the third preset relationship is satisfied between the detection result for the processor utilization rate and the second preset utilization rate threshold; and/or the fourth preset relationship is satisfied between the remaining internal memory capacity and the second preset internal memory capacity threshold, it is determined that the detection result satisfies the condition for canceling collaborative caching. The terminal may transmit the collaboration cancellation request to the network collaboration node; the network collaboration node may delete a corresponding data caching queue after receiving the collaboration cancellation request; and subsequently the network collaboration node will no longer cache corresponding traffic data for the terminal. The terminal with improved device performance can exit the collaborative caching mechanism, thus reducing the caching pressure of the network collaboration node.

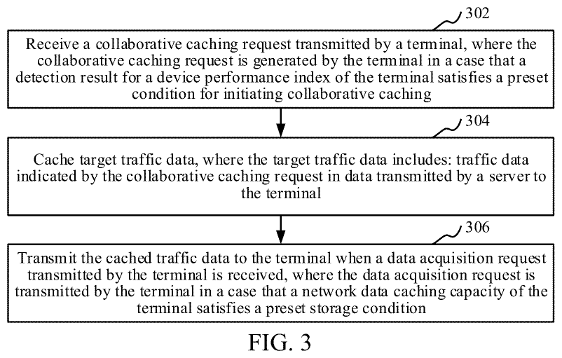

In some embodiments, referring to FIG. 3, a data caching method is provided. Description is made by taking the method being applied to a network collaboration node as an example. The network collaboration node is an intermediate node through which data transmitted between a terminal and a server may pass. The network collaboration node may be a previous hop node of the terminal, for example, the network node 1 in FIG. 1. The data caching method includes the following operations:

Operation 302: Receive a collaborative caching request transmitted by the terminal, where the collaborative caching request is generated by the terminal in a case that a detection result for a device performance index of the terminal satisfies a preset condition for initiating collaborative caching.

For the processes that the terminal detects its own device performance index to obtain the detection result, generates the collaborative caching request, and transmits the collaborative caching request to the network collaboration node, reference may be made to the description of some embodiments above.

Operation 304: Cache target traffic data, where the target traffic data includes: traffic data indicated by the collaborative caching request in data transmitted by the server to the terminal.

After receiving the collaborative caching request, the network collaboration node may create a corresponding data caching queue for the collaborative caching request.

After receiving the collaborative caching request, the network collaboration node may parse the collaborative caching request. When the collaborative caching request carries a collaborative caching type field value corresponding to full traffic caching and network configuration information of the terminal, the network collaboration node may create a corresponding data caching queue for the network configuration information of the terminal. When the collaborative caching request carries a collaborative caching type field value corresponding to partial traffic caching, a traffic identifier, and the network configuration information of the terminal, the network collaboration node may create a corresponding data caching queue for the traffic identifier.

There may be situations that multiple terminals may use collaborative caching. For each collaborative caching request received, the network collaboration node stores information carried in the collaborative caching request locally as a set of data in a case that its own device performance allows to participate in collaborative caching. At least one set of data is stored locally. After receiving a to-be-processed traffic message from the server each time, the network collaboration node extracts a destination address from the to-be-processed traffic message and matches an IP address in each set of locally stored data with the destination address. In a case that matching succeeds, it is determined that a terminal corresponding to the destination address initiates collaborative caching. In a case that matching fails, it is determined that the terminal corresponding to the destination address does not initiate collaborative caching, and the to-be-processed traffic message is directly forwarded to the terminal.

In a case that the terminal corresponding to the destination address extracted by the network collaboration node initiates collaborative caching, traffic data in the to-be-processed traffic message is used as target traffic data, a collaborative caching type may be searched in the successfully matched set of data, and in a case that the searched collaborative caching type is full traffic caching, the target traffic data is cached in a data caching queue created by the network collaboration node for the network configuration information in the set of data. In a case that the searched collaborative caching type is partial traffic caching, a to-be-matched traffic identifier is determined based on the network configuration information in the to-be-processed traffic message. In a case that the to-be-matched traffic identifier matches with a traffic identifier in the set of data, the target traffic data is cached in a data caching queue created by the network collaboration node for the traffic identifier in the set of data.

Operation 306: Transmit the cached traffic data to the terminal when a data acquisition request transmitted by the terminal is received, where the data acquisition request is transmitted by the terminal in a case that a network data caching capacity of the terminal satisfies a preset storage condition.

In some embodiments, when detecting that its own network data caching capacity satisfies the preset storage condition, the terminal may determine a data volume of to-be-acquired traffic data based on the network data caching capacity, generate the data acquisition request based on the data volume and transmit the data acquisition request to the network collaboration node. The network collaboration node may parse the data acquisition request, extract traffic data matching the data volume obtained by parsing from a target data caching queue, and transmit the extracted traffic data to the terminal. The target data caching queue is a data caching queue created in advance for the collaborative caching request.

In some embodiments, the terminal may detect its own device performance index. In a case that the detection result satisfies the preset condition for initiating collaborative caching, the collaborative caching request is transmitted to the network collaboration node. The network collaboration node caches the traffic data indicated by the collaborative caching request in the data transmitted by the server to the terminal after receiving the collaborative caching request. This mode that the network collaboration node assists the terminal with relatively poor device performance in caching data can avoid problems such as lagging and screen flickering caused by excessive processing load of the terminal with relatively poor device performance, reduce packet loss caused by poor device performance of the terminal, and lower the data retransmission rate of the server.

In some embodiments, the data caching method further includes: detect the device performance index of the network collaboration node; and generate a collaboration request confirmation message based on a field value corresponding to collaborative caching participation in a case that the detection result indicates that a processing load of the network collaboration node satisfies a preset condition, and transmit the collaboration request confirmation message to the terminal.

After receiving the collaborative caching request transmitted by the terminal, the network collaboration node detects its own device performance index and determines whether to participate in collaborative caching initiated by the terminal based on the detection result.

The device performance index of the network collaboration node may be information that can reflect device performance of the network collaboration node. The device performance index of the network collaboration node may include: at least one of device configuration of the network collaboration node or performance of the network collaboration node. The device configuration of the network collaboration node may include at least one of model of a processor used by the network collaboration node, internal memory configuration, and storage configuration. The performance of the network collaboration node may include: at least one of a processor utilization rate, a remaining internal memory capacity, and a remaining storage space.

In some embodiments, the device performance index of the network collaboration node may be detected, when the detected device performance index indicates that the performance of the network collaboration node is relatively poor, it is determined that the processing load of the network collaboration node does not satisfy the preset condition; and when the detected device performance index indicates that the performance of the network collaboration node is relatively good, it is determined that the processing load of the network collaboration node satisfies the preset condition.

A device performance threshold may be preset for the device performance index of the network collaboration node, and a performance range corresponding to relatively poor performance and a performance range corresponding to relatively good performance may be determined based on the device performance threshold. When it is detected that the device performance index of the network collaboration node is within the performance range corresponding to relatively poor performance, it is determined that the performance of the network collaboration node is relatively poor, and then it is determined that the processing load of the network collaboration node does not satisfy the preset condition. When it is detected that the device performance index of the network collaboration node is within the performance range corresponding to relatively good performance, it is determined that the performance of the network collaboration node is relatively good, and then it is determined that the processing load of the network collaboration node satisfies the preset condition.

In a case that the device performance index of the network collaboration node is the device configuration of the network collaboration node, and the device configuration of the network collaboration node includes the model of the processor used by the network collaboration node, the internal memory configuration, and the storage configuration, the model of the processor used by the network collaboration node is compared with a preset model, the internal memory configuration of the network collaboration node is compared with a preset internal memory configuration, and the storage configuration of the network collaboration node is compared with a preset storage configuration. In a case that the model of the processor used by the network collaboration node is better than the preset model, the internal memory configuration of the network collaboration node is better than the preset internal memory configuration, and the storage configuration of the network collaboration node is better than the preset storage configuration, it is determined that the performance of the network collaboration node is relatively good. In a case that the model of the processor used by the network collaboration node is poorer than the preset model, or the internal memory configuration of the network collaboration node is poorer than the preset internal memory configuration, or the storage configuration of the network collaboration node is poorer than the preset storage configuration, it is determined that the performance of the network collaboration node is relatively poor.

In a case that the device performance index of the network collaboration node is the performance of the network collaboration node, and the performance of the network collaboration node includes the processor utilization rate, the remaining internal memory capacity, and the remaining storage space, a detection result for the processor utilization rate of the network collaboration node is compared with a preset utilization rate threshold, the remaining internal memory capacity of the network collaboration node is compared with a preset internal memory capacity threshold, and the remaining storage space of the network collaboration node is compared with a preset space threshold. In a case that the processor utilization rate of the network collaboration node is less than the preset utilization rate threshold, the remaining internal memory capacity of the network collaboration node is greater than the preset internal memory capacity threshold, and the remaining storage space of the network collaboration node is greater than the preset space threshold, it is determined that the performance of the network collaboration node is relatively good. In a case that the processor utilization rate of the network collaboration node is greater than the preset utilization rate threshold, or the remaining internal memory capacity of the network collaboration node is less than the preset internal memory capacity threshold, or the remaining storage space of the network collaboration node is less than the preset space threshold, it is determined that the performance of the network collaboration node is relatively poor.

In some embodiments, when the processing load of the network collaboration node satisfies the preset condition, the network collaboration node may determine to participate in collaborative caching initiated by the terminal. The network collaboration node may generate the collaboration request confirmation message based on the field value corresponding to collaborative caching participation and transmit the collaboration request confirmation message to the terminal. When the processing load of the network collaboration node does not satisfy the preset condition, the network collaboration node may determine to refuse to participate in collaborative caching initiated by the terminal. The network collaboration node may generate the collaboration request confirmation message based on a field value corresponding to collaborative caching participation refusal and transmit the collaboration request confirmation message to the terminal.

A target field for indicating whether the network collaboration node participates in collaborative caching may be set in the collaboration request confirmation message. The target field may be expressed as Join_coll. In a case that the network collaboration node determines to participate in collaborative caching initiated by the terminal, the value of the target field may be set to 1; and in a case that the network collaboration node determines to refuse to participate in collaborative caching initiated by the terminal, the value of the target field may be set to 0.

After receiving the collaboration request confirmation message, the terminal may confirm whether the network collaboration node participates in collaborative caching based on the target field in the collaboration request confirmation message.

In some embodiments, the network collaboration node detects its own device performance index after receiving the collaborative caching request transmitted by the terminal, participates in collaborative caching initiated by the terminal in a case that its own performance allows, and does not participate in collaborative caching initiated by the terminal in a case that its own performance does not allow. This negotiation mechanism provides flexible selectivity for the network collaboration node to participate in collaborative caching, thus avoiding the problem of high processing load caused by participation in collaborative caching when its own performance is relatively poor.

In some embodiment, the operation of caching the target traffic data includes: extract the destination address from the to-be-processed traffic message after the to-be-processed traffic message from the server is received, and extract the network configuration information of the terminal from the collaborative caching request; match a network address in the network configuration information of the terminal with the destination address; and use traffic data in the to-be-processed traffic message as the target traffic data in a case that matching succeeds, and cache the target traffic data based on a type field value carried in the collaborative caching request.

Normal traffic communication operations are performed between the terminal and the server, The traffic communication operations include that the terminal transmits a data traffic request to the server, the server responds to the data traffic request, the terminal transmits a confirmation message to the server after receiving data packets, a data transmission connection is closed, and the like.

The operation that the terminal transmits the data traffic request to the server may include: generate a corresponding data traffic request after the terminal detects an opening operation for certain data, and transmit the data traffic request to the server. The operation that the server responds to the data traffic request may include: the server delivers corresponding data to the terminal in the form of data packets based on the received data traffic request. The operation that the terminal transmits the confirmation message to the server after receiving the data packets may include: the terminal returns a corresponding confirmation message to the server after receiving a data packet each time, so that the server knows that the data packet is successfully transmitted. The operation that the data transmission connection is closed may include: transmit a request for closing the connection to the server when the terminal detects a closing operation for the data, and close the connection configured for transmitting the corresponding data after the server receives the request.

The server can query whether there is a situation that the terminal does not receive certain data packet based on the received confirmation message. When it is determined that the terminal does not receive certain data packet, the server may retransmit the data packet.

The data packets delivered by the server to the terminal may be placed in the traffic message. The traffic message may also include a destination address, a destination port number, and the like. The traffic message may be forwarded by various network nodes to reach the terminal. When the traffic message is transmitted to the network collaboration node, the network collaboration node may use the traffic message as a to-be-processed traffic message, and extract the destination address from the to-be-processed traffic message to determine whether data packets in the to-be-processed traffic message are target traffic data that may be cached.

In some embodiments, after receiving each collaborative caching request, the network collaboration node may extract the network configuration information of the terminal from the collaborative caching request and locally store the extracted network configuration information of the terminal in a case that its own device performance allows to participate in collaborative caching. Therefore, network configuration information of multiple terminals is locally stored. The network collaboration node may match the destination address in the to-be-processed traffic message with a network address in the locally stored network configuration information. In a case that matching succeeds, the data packets in the to-be-processed traffic message are used as the target traffic data that may be cached; and in a case that matching fails, the to-be-processed traffic message is forwarded to a terminal corresponding to the destination address.

When it is determined that the data packets in the to-be-processed traffic message are used as the target traffic data that may be cached, the network collaboration node acquires a type field value corresponding to the successfully matched network configuration information, for example, a type field value carried in the collaborative caching request corresponding to the network configuration information, and caches the target traffic data based on the type field value.

In some embodiments above, the network collaboration node extracts the destination address from the to-be-processed traffic message after receiving the to-be-processed traffic message from the server, determines whether traffic packets in the to-be-processed traffic message are the target traffic data that may be cached based on the destination address, and caches the target traffic data in a case that a determination result is yes. This mode that the network collaboration node assists the terminal with relatively poor device performance in caching data can avoid problems such as lagging and screen flickering caused by excessive processing load of the terminal with relatively poor device performance, reduce the packet loss caused by poor device performance of the terminal, and lower the data retransmission rate of the server.

In some embodiment, the operation of caching the target traffic data based on the type field value carried in the collaborative caching request includes: cache the target traffic data in a first data caching queue when the type field value carried in the collaborative caching request indicates that a collaborative caching type is full traffic caching, where the first data caching queue is a data caching queue created for the network configuration information in the collaborative caching request.

After receiving each collaborative caching request, in a case that it is determined that its own device performance allows to participate in collaborative caching, in addition to locally storing the information carried in the collaborative caching request, the network collaboration node may also create a corresponding data caching queue for the collaborative caching request.

In some embodiments, in a case that the collaborative caching request carries the collaborative caching type field value corresponding to full traffic caching and the network configuration information of the terminal, a corresponding data caching queue is created for the network configuration information of the terminal. In a case that the collaborative caching request carries the collaborative caching type field value corresponding to partial traffic caching, the traffic identifier, and the network configuration information of the terminal, a corresponding data caching queue is created for the traffic identifier.

In a case that the network collaboration node determines that the traffic data in the to-be-processed traffic message is used as the target traffic data, a type field value corresponding to the network configuration information that matches the destination address successfully, for example, a type field value carried in the collaborative caching request corresponding to the network configuration information may be acquired. When the type field value indicates that the collaborative caching type is full traffic caching, the target traffic data is cached in the first data caching queue. The first data caching queue is a data caching queue created by the network collaboration node for the network configuration information in the collaborative caching request.

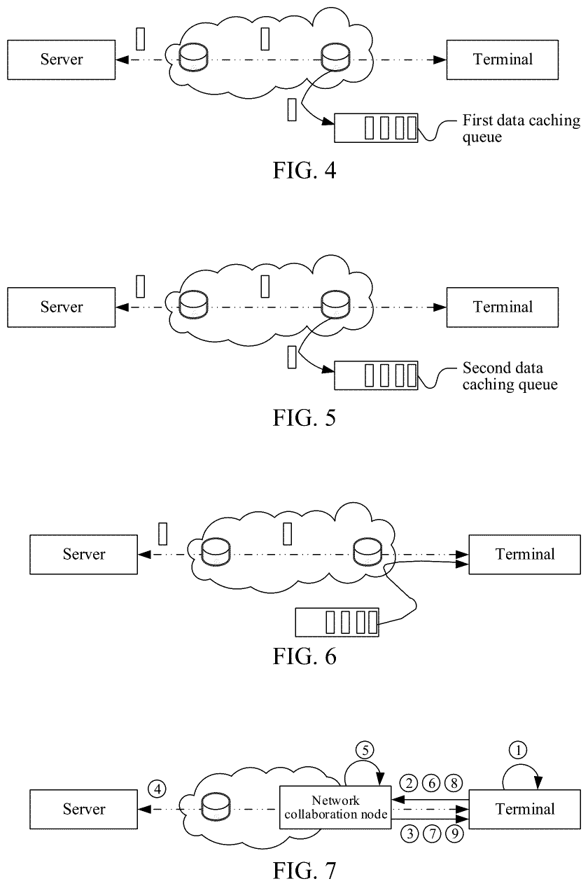

Referring to FIG. 4, the first data caching queue follows a first-in first-out principle. If a data packet A is stored in the first data caching queue earlier than a data packet B, the data packet A will also be transmitted to the terminal earlier than the data packet B.

In some embodiments, when the type field value carried in the collaborative caching request indicates that the collaborative caching type is full traffic caching, the target traffic data is cached in the first data caching queue. The first data caching queue is a data caching queue created for the network configuration information in the collaborative caching request. This mode can avoid problems such as lagging and screen flickering caused by excessive processing load on the terminal with relatively poor device performance, reduce the packet loss caused by poor device performance of the terminal, and lower the data retransmission rate of the server. In a case that the device performance of the terminal is very poor, the network collaboration node may assist the terminal in caching all to-be-received data, thus alleviating the processing pressure of the terminal and improving the service experience problems such as lagging, screen flickering, and mosaic.

In some embodiment, the operation of caching the target traffic data based on the type field value carried in the collaborative caching request includes: determine a to-be-matched traffic identifier based on the network configuration information in the to-be-processed traffic message when the type field value carried in the collaborative caching request indicates that the collaborative caching type is partial traffic caching; match the to-be-matched traffic identifier with a traffic identifier in the collaborative caching request; and cache the target traffic data in a second data caching queue in a case that matching succeeds, where the second data caching queue is a data caching queue created for the traffic identifier in the collaborative caching request.

In a case that the network collaboration node determines that the traffic data in the to-be-processed traffic message is used as the target traffic data, a type field value corresponding to the network configuration information that matches the destination address successfully, for example, a type field value carried in the collaborative caching request corresponding to the network configuration information may be acquired. When the type field value carried in the collaborative caching request indicates that the collaborative caching type is partial traffic caching, the network collaboration node determines the to-be-matched traffic identifier based on the network configuration information in the to-be-processed traffic message.

In a case that the network protocol may be Transmission Control Protocol (TCP) or User Datagram Protocol (UDP), the network configuration information in the to-be-processed traffic message includes: a destination address, a destination port number, an IP address of the server, a port number of the server, and a network protocol. The network collaboration node may determine the to-be-matched traffic identifier based on the destination address, the destination port number, the IP address of the server, the port number of the server, and the network protocol.

The to-be-matched traffic identifier may be determined through the following formula:

$${FlowID}^{′} = Hash ( {src}^{′} ‖ {dst}^{′} ‖ {sport}^{′} ‖ {dport}^{′} ‖ {prot}^{′} )$$

where FlowID′ is the to-be-matched traffic identifier, src is the IP address of the server, dst is the destination address, sport is the port number of the server, dport is the destination port number, and prot is the network protocol. The symbol “∥” represents a character string concatenation operation. src′∥dst′∥sport′∥dport′∥prot′ is a concatenation result obtained by concatenating the destination address, the destination port number, the IP address of the server, the port number of the server, and the network protocol. Hash ( ) function represents the hash operation.

In a case that the network protocol between the terminal and the server is quick udp Internet connection (QUIK), the to-be-processed traffic message carries a connection identifier, and the network collaboration node may extract the connection identifier from the to-be-processed traffic message and use the extracted connection identifier as the to-be-matched traffic identifier.

The network collaboration node may acquire a collaborative caching request corresponding to the network configuration information that matches the destination address successfully, and match the to-be-matched traffic identifier with a traffic identifier in the collaborative caching request. In a case that matching succeeds, target traffic data is cached in a second data caching queue. The second data caching queue is a data caching queue created for the traffic identifier in the collaborative caching request. In a case that matching fails, the to-be-processed traffic message is forwarded to a terminal corresponding to the destination address.

Referring to FIG. 5, the second data caching queue follows a first-in first-out principle. If a data packet A is stored in the second data caching queue earlier than a data packet B, the data packet A will also be transmitted to the terminal earlier than the data packet B.

In some embodiments, when the type field value carried in the collaborative caching request indicates that the collaborative caching type is partial traffic caching, the to-be-matched traffic identifier is determined based on the network configuration information in the to-be-processed traffic message; the to-be-matched traffic identifier is matched with the traffic identifier in the collaborative caching request; and the target traffic data is cached in the second data caching queue in a case that matching succeeds, where the second data caching queue is a data caching queue created for the traffic identifier in the collaborative caching request. In a case that the device performance of the terminal is slightly poor, the network collaboration node may assist the terminal in caching data traffic corresponding to media data under processing by the terminal, thus alleviating the processing pressure of the terminal and improving the service experience problems such as lagging, screen flickering, and mosaic.

In some embodiments, the data caching method further includes: receive the data acquisition request transmitted by the terminal; and parse the data acquisition request, extract the traffic data matching the data volume obtained by parsing from the target data caching queue, and transmit the extracted traffic data to the terminal, where the target data caching queue is a data caching queue created in advance for the collaborative caching request.

For the processes that the terminal generates the data acquisition request and transmits the data acquisition request to the network collaboration node, reference may be made to the description of some embodiments above.

After receiving the data acquisition request, the network collaboration node parses the data acquisition request, searches for the target data caching queue based on a parsing result, extracts traffic data matching the data volume obtained by parsing from the target data caching queue, and transmits the extracted traffic data to the terminal.

After the network collaboration node receives the data acquisition request, the data acquisition request is parsed; in a case that the parsing result includes the network configuration information of the terminal and the data volume, a data caching queue created in advance for the network configuration information is used as the target data caching queue, traffic data matching the data volume is extracted from the target data caching queue, and the extracted traffic data is transmitted to the terminal; and in a case that the parsing result includes the traffic identifier and the data volume, a data caching queue created in advance for the traffic identifier is used as the target data caching queue, traffic data matching the data volume is extracted from the target data caching queue, and the extracted traffic data is transmitted to the terminal. Referring to FIG. 6, the network collaboration node may extract the traffic data matching the data volume from the target data caching queue according to a first-in first-out principle, and transmit the extracted traffic data to the terminal.

In some embodiments, after the data acquisition request transmitted by the terminal is received, the data acquisition request is parsed, the traffic data matching the data volume obtained by parsing is extracted from target data caching queue, and the extracted traffic data is transmitted to the terminal. The target data caching queue is a data caching queue created in advance for the collaborative caching request. In a case that the device performance of the terminal is relatively poor, the network collaboration node may assist the terminal in caching all to-be-received data; and when the network data caching capacity of the terminal can accommodate new traffic data, it may request the network collaboration node to deliver the data, thus alleviating the processing pressure of the terminal and improving the service experience problems such as lagging, screen flickering, and mosaic.

In some embodiments, the data caching method further includes: receive a collaboration cancellation request transmitted by the terminal, where the collaboration cancellation request is generated by the terminal in a case that the terminal detects that the device performance index of the terminal satisfies a condition for canceling collaborative caching; and delete a data caching queue indicated by the collaboration cancellation request, and transmit a collaborative caching cancellation message to the terminal.

For the process that the terminal generates the collaboration cancellation request, reference may be made to the description of some embodiments above.

After receiving the collaboration cancellation request, the network collaboration node may parse the received collaboration cancellation request, search for a data caching queue corresponding to the network configuration information obtained by parsing, and delete the data caching queue. After deleting the data caching queue, the network collaboration node may transmit a collaborative caching cancellation message to the terminal, and subsequently the network collaboration node will no longer cache traffic data for the terminal. The collaborative caching cancellation message may be expressed as Pkt_coll_cancle_ack.

In some embodiments, after the network collaboration node receives the collaboration cancellation request transmitted by the terminal, the data caching queue indicated by the collaboration cancellation request is deleted, and the collaborative caching cancellation message is transmitted to the terminal. Subsequently the network collaboration node will no longer cache traffic data for the terminal. The terminal with improved device performance can exit the collaborative caching mechanism, thus reducing the caching pressure of the network collaboration node.

In some embodiments, the data caching method further includes: perform utilization rate detection on the data caching queue created in advance for the collaborative caching request; and deliver a preset amount of traffic data to the terminal from the data caching queue created in advance for the collaborative caching request when a utilization rate satisfies a traffic delivery condition.

In some embodiments, in a case that the collaborative caching request carries the collaborative caching type field value corresponding to full traffic caching and the network configuration information of the terminal, the network collaboration node may create a corresponding data caching queue for the network configuration information of the terminal, perform utilization rate detection on the data caching queue, determine that the utilization rate satisfies the traffic delivery condition in a case that the utilization rate exceeds a preset caching threshold, extract a preset amount of traffic data from the data caching queue, and transmit the traffic data to the terminal. The preset caching threshold and the preset amount may be preset or agreed through the collaborative caching request, which will not be limited here.

In some embodiments, in a case that the collaborative caching request carries the collaborative caching type field value corresponding to partial traffic caching, the traffic identifier, and the network configuration information of the terminal, the network collaboration node may create a corresponding data caching queue for the traffic identifier, perform utilization rate detection on the data caching queue, determine that the utilization rate satisfies the traffic delivery condition in a case that the utilization rate exceeds a preset caching threshold, extract a preset amount of traffic data from the data caching queue, and transmit the traffic data to the terminal.

The utilization rate detection on the data caching queue may be real-time detection, regular detection, periodic detection, or detection carried out according to a preset detection rule. However, the disclosure is not limited thereto.

In some embodiments, utilization rate detection is performed on the data caching queue created in advance for the collaborative caching request; and a preset amount of traffic data is delivered to the terminal from the data caching queue created in advance for the collaborative caching request when the utilization rate satisfies the traffic delivery condition. This mode that the network collaboration node assists the terminal with relatively poor device performance in caching data can improve the service experience problems such as lagging, screen flickering, and mosaic on the terminal.

In some embodiments, the data caching method further includes: deliver a preset amount of traffic data to the terminal from the data caching queue created in advance for the collaborative caching request according to a preset time rule.

After receiving the collaborative caching request transmitted by the terminal, in a case that it is determined to participate in collaborative caching initiated by the terminal, the network collaboration node creates a corresponding data caching queue for the collaborative caching request.

The preset time rule may include a preset duration threshold. The network collaboration node may deliver a preset amount of traffic data to the terminal from the data caching queue every preset duration threshold. The preset duration threshold and the preset amount may be preset or agreed through the collaborative caching request, which will not be limited here.

In some embodiments, in a case that the collaborative caching request carries the collaborative caching type field value corresponding to full traffic caching and the network configuration information of the terminal, the network collaboration node may create a corresponding data caching queue for the network configuration information of the terminal. The network collaboration node may extract a preset amount of traffic data from the data caching queue every preset duration threshold, and transmit the traffic data to the terminal.

In some embodiments, in a case that the collaborative caching request carries the collaborative caching type field value corresponding to partial traffic caching, the traffic identifier, and the network configuration information of the terminal, the network collaboration node may create a corresponding data caching queue for the traffic identifier. The network collaboration node may extract a preset amount of traffic data from the data caching queue every preset duration threshold, and transmit the traffic data to the terminal.

In some embodiments, the preset amount of traffic data is delivered to the terminal from the data caching queue created in advance for the collaborative caching request according to the preset time rule. This mode that the network collaboration node assists the terminal with relatively poor device performance in caching data can improve the service experience problems such as lagging, screen flickering, and mosaic on the terminal.

In some embodiments, a data caching method is provided. Description is made by taking the method being executed by a terminal as an example. The method includes:
when it is detected by the terminal that a first preset relationship is maintained between a detection result for a processor utilization rate and a first preset utilization rate threshold for a duration exceeding a first duration threshold; and/or, when it is detected that a second preset relationship is maintained between a detection result for a remaining internal memory capacity and a first preset internal memory capacity threshold for a duration exceeding a second duration threshold, determine that the detection result satisfies a preset condition for initiating collaborative caching.

The terminal determines a collaborative caching type based on the detection result. In a case that the collaborative caching type is full traffic caching, a collaborative caching request is generated based on a collaborative caching type field value corresponding to full traffic caching and network configuration information of the terminal. In a case that the collaborative caching type is partial traffic caching, the network configuration information of the terminal, network configuration information of a server, and a network protocol for communication between the terminal and the server are acquired; the network configuration information of the terminal, the network configuration information of the server, and the network protocol are concatenated to obtain a concatenation result; the concatenation result is encrypted and an encrypted result is used as a traffic identifier for media data under processing by the terminal; or, a connection identifier determined through negotiation between the terminal and the server for transmitting the media data under processing by the terminal is used as the traffic identifier for the media data under processing by the terminal; and the collaborative caching request is generated based on a collaborative caching type field value corresponding to partial traffic caching, the traffic identifier, and the network configuration information of the terminal.

The terminal determines a network collaboration node through which data transmitted between the terminal and the server may pass, and transmits the collaborative caching request to the network collaboration node, and the network collaboration node performs detection on a device performance index; and a collaboration request confirmation message is generated based on a field value corresponding to collaborative caching participation in a case that the detection result indicates that a processing load of the network collaboration node satisfies a preset condition, and the collaboration request confirmation message is transmitted to the terminal.

After the network collaboration node receives a to-be-processed traffic message from the server, a destination address is extracted from the to-be-processed traffic message, and the network configuration information of the terminal is extracted from the collaborative caching request; a network address in the network configuration information of the terminal is matched with the destination address; and in a case that matching succeeds, traffic data in the to-be-processed traffic message is used as target traffic data; when a type field value carried in the collaborative caching request indicates that the collaborative caching type is full traffic caching, the target traffic data is cached in a first data caching queue, where the first data caching queue is a data caching queue created for the network configuration information in the collaborative caching request. When the type field value carried in the collaborative caching request indicates that the collaborative caching type is partial traffic caching, a to-be-matched traffic identifier is determined based on the network configuration information in the to-be-processed traffic message; the to-be-matched traffic identifier is matched with a traffic identifier in the collaborative caching request; and the target traffic data is cached in a second data caching queue in a case that matching succeeds, where the second data caching queue is a data caching queue created for the traffic identifier in the collaborative caching request.

In a case that the collaborative caching type is full traffic caching, when it is detected that a network data caching capacity of the terminal satisfies a preset storage condition, a data volume of to-be-acquired traffic data is determined based on the network data caching capacity; a data acquisition request is generated based on the network configuration information of the terminal and the data volume; and the data acquisition request is transmitted to the network collaboration node. In a case that the collaborative caching type is partial traffic caching, when it is detected that the network data caching capacity of the terminal satisfies the preset storage condition, the data volume of to-be-acquired traffic data is determined based on the network data caching capacity; the data acquisition request is generated based on the traffic identifier and the data volume; and the data acquisition request is transmitted to the network collaboration node.

The network collaboration node parses the data acquisition request, extracts traffic data matching the data volume obtained by parsing from a target data caching queue, and transmits the extracted traffic data to the terminal. The target data caching queue is a data caching queue created in advance for the collaborative caching request. Utilization rate detection may be performed on the data caching queue created in advance for the collaborative caching request; and a preset amount of traffic data is delivered to the terminal from the data caching queue created in advance for the collaborative caching request when a utilization rate satisfies a traffic delivery condition. A preset amount of traffic data is delivered to the terminal from the data caching queue created in advance for the collaborative caching request according to a preset time rule.

When it is detected by the terminal that a third preset relationship is satisfied between a detection result for the processor utilization rate and a second preset utilization rate threshold; and/or, when it is detected that a fourth preset relationship is satisfied between a detection result for the remaining internal memory capacity and a second preset internal memory capacity threshold, it is determined that the detection result satisfies a condition for canceling collaborative caching, and a collaboration cancellation request is generated based on a collaborative caching type field value corresponding to collaborative caching cancellation and the network configuration information of the terminal; and the collaboration cancellation request is transmitted to the network collaboration node.

The network collaboration node deletes a data caching queue indicated by the collaboration cancellation request, and transmits a collaborative caching cancellation message to the terminal.

In some embodiments, the terminal may detect its own device performance index. In a case that a detection result satisfies the preset condition for initiating collaborative caching, the collaborative caching request is transmitted to the network collaboration node. The network collaboration node caches traffic data indicated by the collaborative caching request in the data transmitted by the server to the terminal after receiving the collaborative caching request, and transmits the cached traffic data to the terminal after receiving the data acquisition request transmitted by the terminal. This mode that the network collaboration node assists the terminal with relatively poor device performance in caching data can avoid problems such as lagging and screen flickering caused by excessive processing load of the terminal with relatively poor device performance, reduce packet loss caused by poor device performance of the terminal, and lower the data retransmission rate of the server.

In some embodiments, referring to FIG. 7, the data caching method may include the following steps: \textcircled{1} a terminal performs periodic detection on its own device performance index; \textcircled{2} transmit a collaborative caching request to a previous hop network node (network collaboration node) in a case that a detection result satisfies a preset condition for initiating collaborative caching; \textcircled{3} the network collaboration node returns a collaboration request confirmation message to the terminal after receiving the collaborative caching request; \textcircled{4} a cloud server transmits a traffic data message to the terminal after receiving a traffic request message from the terminal; \textcircled{5} the network collaboration node uses the traffic message as a to-be-processed traffic message after receiving the traffic message transmitted from the cloud server to the terminal, and caches data packets in the to-be-processed traffic message in a case that it is determined that a terminal corresponding to a destination address in the to-be-processed traffic message initiates collaborative caching; \textcircled{6} the terminal periodically transmits a data acquisition request to the network collaboration node; \textcircled{7} the network collaboration node transmits corresponding traffic data to the terminal based on the received data acquisition request; \textcircled{8} transmit a collaboration cancellation request to the network collaboration node when the device performance index of the terminal is improved or media data under processing by the terminal is closed; and \textcircled{9} the network collaboration node transmits a collaborative caching cancellation message to the terminal and no longer performs a collaborative caching operation on subsequent related traffic data.

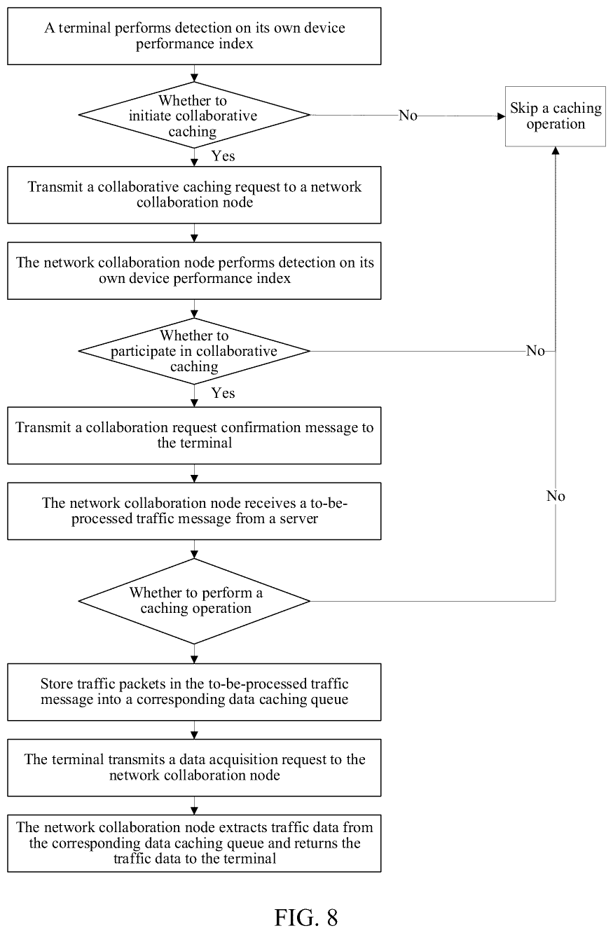

In some embodiments, referring to FIG. 8, the terminal detects its own device performance index and determines whether to initiate collaborative caching based on the detection result. In a case that a determination result is to initiate collaborative caching, the terminal generates a collaborative caching request based on the detection result and transmits the collaborative caching request to the network collaboration node. The network collaboration node detects its own device performance index, determines whether to participate in collaborative caching based on its own device performance index, and transmits a collaboration request confirmation message to the terminal in a case that a determination result is to participate in collaborative caching. The network collaboration node receives a to-be-processed traffic message from the server, determines whether to cache traffic packets in the to-be-processed traffic message based on a destination address in the to-be-processed traffic message, and stores the traffic packets in the to-be-processed traffic message in a corresponding data caching queue in a case that a determination result is to perform caching. When it is detected that a network data caching capacity satisfies a preset storage condition, the terminal transmits a data acquisition request to the network collaboration node. The network collaboration node extracts traffic data from the corresponding data caching queue and transmits the traffic data to the terminal.

In some possible scenarios, the data that the network collaboration node assists the terminal in caching may be video data. In a case that the detection result for the device performance index of the terminal satisfies a preset condition for initiating collaborative caching, the terminal generates the collaborative caching request based on the detection result, and transmits the collaborative caching request to the network collaboration node; and after receiving a video traffic message from the server, the network collaboration node extracts a destination address in the video traffic message, determines whether to cache data packets in the video traffic message based on the destination address, and stores the traffic packets in the video traffic message in a corresponding data caching queue in a case that a determination result is to perform caching. When it is detected that the network data caching capacity satisfies the preset storage condition, the terminal transmits a video data acquisition request to the network collaboration node. The network collaboration node extracts video traffic data from the corresponding data caching queue and transmits the video traffic data to the terminal.

The application scenarios provided above are only for describing the data caching method provided and the application scenarios of the data caching method provided in some embodiments are not limited to the application scenarios provided above. For example, it may also be applied in audio scenarios, file transfer scenarios, web browsing scenarios, and so on. However, the disclosure is not limited thereto.

Although the operations in the flowcharts involved in some embodiments above are displayed sequentially according to the instructions of the arrows, these operations are not necessarily performed sequentially according to the sequence instructed by the arrows. Unless otherwise explicitly specified in some embodiments, execution of the operations is not strictly limited, and the operations may be performed in other sequences. Moreover, at least part of the operations in the flowcharts involved in some embodiments above may include multiple operations or multiple stages. These operations or stages are not necessarily executed at the same time, but may be executed at different times. These operations or stages are not necessarily performed sequentially, but may be performed in turn or alternately with other operations or at least part of operations or stages of other operations.

Some embodiments further provide a data caching apparatus for implementing the data caching method mentioned above. The implementation solution provided for the apparatus to solve the problem is similar to the implementation solution described in the above method. For the limitations of one or more data caching apparatus embodiments provided below, reference may be made to the limitations of the data caching method mentioned above.

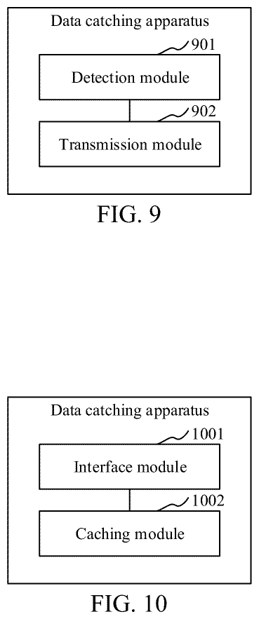

In some embodiments, referring to FIG. 9, a data caching apparatus is provided, which includes:
a detection module 901, configured to acquire a detection result for a device performance index of a terminal; and analyze the detection result to determine whether the detection result satisfies a preset condition for initiating collaborative caching; and
a transmission module 902, configured to determine a network collaboration node through which data transmitted between the terminal and a server may pass in response to the detection result satisfying the preset condition, and generate a collaborative caching request; transmit the collaborative caching request to the network collaboration node, where the collaborative caching request is configured for instructing the network collaboration node to cache target traffic data, and the target traffic data includes traffic data indicated by the collaborative caching request in data transmitted by the server to the terminal; transmit a data acquisition request to the network collaboration node in response to a network data caching capacity of the terminal satisfying a preset storage condition; and receive the cached target traffic data transmitted by the network collaboration node in response to the data acquisition request.

In some embodiments, the device performance index includes: at least one of a processor utilization rate and a remaining internal memory capacity. The method further includes: the detection module 901 may be configured to: determine that the detection result satisfies the preset condition for initiating collaborative caching when at least one of a first preset condition and a second preset condition is satisfied; where the first preset condition is that: a first preset relationship is maintained between a detection result for the processor utilization rate and a first preset utilization rate threshold for a duration exceeding a first duration threshold; and the second preset condition is that: a second preset relationship is maintained between a detection result for the remaining internal memory capacity and a first preset internal memory capacity threshold for a duration exceeding a second duration threshold.

In some embodiments, the detection module 901 may be configured to: determine a collaborative caching type based on the detection result; and generate the collaborative caching request based on the collaborative caching type.

In some embodiments, the detection module 901 may be configured to: generate the collaborative caching request based on a collaborative caching type field value corresponding to full traffic caching and network configuration information of the terminal in a case that the collaborative caching type is full traffic caching.

In some embodiments, the transmission module 902 is further configured to: determine a data volume of to-be-acquired traffic data based on the network data caching capacity in a case that it is detected that the network data caching capacity of the terminal satisfies the preset storage condition; generate the data acquisition request based on the network configuration information of the terminal and the data volume; transmit the data acquisition request to the network collaboration node, where the data acquisition request is configured for instructing the network collaboration node to parse the received data acquisition request, search for a data caching queue corresponding to the network configuration information obtained by parsing, and extract traffic data matching a data volume obtained by parsing from the searched data caching queue; and receive traffic data returned by the network collaboration node.

In some embodiments, the transmission module 902 is further configured to: generate a collaboration cancellation request based on a collaborative caching type field value corresponding to collaborative caching cancellation and the network configuration information of the terminal in a case that it is detected that the device performance index of the terminal satisfies a condition for canceling collaborative caching; transmit the collaboration cancellation request to the network collaboration node, where the collaboration cancellation request is configured for instructing the network collaboration node to parse the received collaboration cancellation request and delete a data caching queue corresponding to the network configuration information obtained by parsing; and receive a collaborative caching cancellation message transmitted by the network collaboration node.

In some embodiments, the detection module 901 may be configured to: acquire a traffic identifier for media data under processing by the terminal in a case that the collaborative caching type is partial traffic caching; and generate the collaborative caching request based on a collaborative caching type field value corresponding to partial traffic caching, the traffic identifier, and the network configuration information of the terminal.

In some embodiments, the detection module 901 may be configured to: acquire the network configuration information of the terminal, network configuration information of the server, and a network protocol for communication between the terminal and the server; concatenate the network configuration information of the terminal, the network configuration information of the server, and the network protocol to obtain a concatenation result; and encrypt the concatenation result and use an encrypted result as the traffic identifier for the media data under processing by the terminal.

In some embodiments, the detection module 901 may be configured to: use a connection identifier determined through negotiation between the terminal and the server for transmitting the media data under processing by the terminal as the traffic identifier for the media data under processing by the terminal.

In some embodiments, the transmission module 902 is further configured to: determine the data volume of the to-be-acquired traffic data based on the network data caching capacity in a case that it is detected that the network data caching capacity of the terminal satisfies the preset storage condition; generate the data acquisition request based on the traffic identifier and the data volume; transmit the data acquisition request to the network collaboration node, where the data acquisition request is configured for instructing the network collaboration node to parse the received data acquisition request, search for a data caching queue corresponding to the traffic identifier obtained by parsing, and extract traffic data matching the data volume obtained by parsing from the searched data caching queue; and receive traffic data returned by the network collaboration node.

In some embodiments, the transmission module 902 is further configured to: generate the collaboration cancellation request based on a type field value corresponding to collaborative caching cancellation and the traffic identifier in a case that it is detected that the device performance index of the terminal satisfies the condition for canceling collaborative caching; transmit the collaboration cancellation request to the network collaboration node, where the collaboration cancellation request is configured for instructing the network collaboration node to parse the received collaboration cancellation request and delete a data caching queue corresponding to the traffic identifier obtained by parsing; and receive a collaborative caching cancellation message transmitted by the network collaboration node.

In some embodiments, the transmission module 902 is further configured to: receive a collaboration request confirmation message transmitted by the network collaboration node, where the collaboration request confirmation message is configured for indicating whether the network collaboration node participates in collaborative caching, and the collaboration request confirmation message is generated by the network collaboration node based on its own device performance index.

In some embodiments, the transmission module 902 is further configured to: determine that the detection result satisfies the condition for canceling collaborative caching when at least one of a third condition and a fourth condition is satisfied. The third condition is that: a third preset relationship is satisfied between the detection result for the processor utilization rate and a second preset utilization rate threshold. The fourth condition is that: a fourth preset relationship is satisfied between the detection result for the remaining internal memory capacity and a second preset internal memory capacity threshold.

In some embodiments, referring to FIG. 10, a data caching apparatus is provided, which includes:
an interface module 1001, configured to receive a collaborative caching request transmitted by a terminal, where the collaborative caching request is generated by the terminal in a case that a detection result for a device performance index of the terminal satisfies a preset condition for initiating collaborative caching; and
a caching module 1002, configured to cache target traffic data, where the target traffic data includes: traffic data indicated by the collaborative caching request in data transmitted by a server to the terminal.

The interface module 1001 is further configured to transmit the cached target traffic data to the terminal when a data acquisition request transmitted by the terminal is received, where the data acquisition request is transmitted by the terminal in a case that a network data caching capacity of the terminal satisfies a preset storage condition.

In some embodiments, the interface module 1001 is further configured to detect a device performance index of the network collaboration node; and generate a collaboration request confirmation message based on a field value corresponding to collaborative caching participation in a case that the detection result indicates that a processing load of the network collaboration node satisfies a preset condition, and transmit the collaboration request confirmation message to the terminal.

In some embodiments, the caching module 1002 may be configured to: extract a destination address from a to-be-processed traffic message after the to-be-processed traffic message from the server is received, and extract the network configuration information of the terminal from the collaborative caching request; match a network address in the network configuration information of the terminal with the destination address; and use traffic data in the to-be-processed traffic message as the target traffic data in a case that matching succeeds, and cache the target traffic data based on a type field value carried in the collaborative caching request.

In some embodiments, the caching module 1002 may be configured to: cache the target traffic data in a first data caching queue when the type field value carried in the collaborative caching request indicates that a collaborative caching type is full traffic caching, where the first data caching queue is a data caching queue created for the network configuration information in the collaborative caching request.

In some embodiments, the caching module 1002 may be configured to: determine a to-be-matched traffic identifier based on the network configuration information in the to-be-processed traffic message when the type field value carried in the collaborative caching request indicates that the collaborative caching type is partial traffic caching; match the to-be-matched traffic identifier with a traffic identifier in the collaborative caching request; and cache the target traffic data in a second data caching queue in a case that matching succeeds, where the second data caching queue is a data caching queue created for the traffic identifier in the collaborative caching request.

In some embodiments, the interface module 1001 is further configured to receive the data acquisition request transmitted by the terminal; and parse the data acquisition request, extract the traffic data matching a data volume obtained by parsing from a target data caching queue, and transmit the extracted traffic data to the terminal, where the target data caching queue is a data caching queue created in advance for the collaborative caching request.

In some embodiments, the interface module 1001 is further configured to receive a collaboration cancellation request transmitted by the terminal, where the collaboration cancellation request is generated by the terminal in a case that the terminal detects that the device performance index of the terminal satisfies a condition for canceling collaborative caching; and delete a data caching queue indicated by the collaboration cancellation request, and transmit a collaborative caching cancellation message to the terminal.

In some embodiments, the interface module 1001 is further configured to perform utilization rate detection on the data caching queue created in advance for the collaborative caching request; and deliver a preset amount of traffic data to the terminal from the data caching queue created in advance for the collaborative caching request when a utilization rate satisfies a traffic delivery condition.

In some embodiments, the interface module 1001 is further configured to deliver a preset amount of traffic data to the terminal from the data caching queue created in advance for the collaborative caching request according to a preset time rule.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

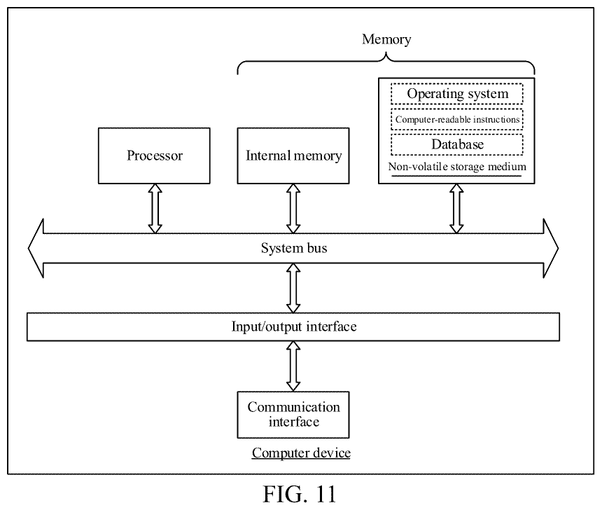

In some embodiments, a computer device is provided. The computer device may be a network collaboration node, and an internal structural diagram thereof may be as shown in FIG. 11. The computer device includes a processor, a memory, an input/output interface (I/O), and a communication interface. The processor, the memory, and the input/output interface are connected through a system bus. The communication interface is connected to the system bus through the input/output interface. The processor of the computer device is configured to provide computing and control abilities. The memory of the computer device includes a non-volatile storage medium and an internal memory. The non-volatile storage medium stores an operating system, computer-readable instructions, and a database. The internal memory provides an environment for the operation of the operating system and the computer-readable instructions in the non-volatile storage medium. The database of the computer device is configured to store target traffic data. The input/output interface of the computer device is configured to exchange information between the processor and external devices. The communication interface of the computer device is configured to communicate with external terminals through a network connection. The computer-readable instructions are executed by the processor to implement a data caching method.

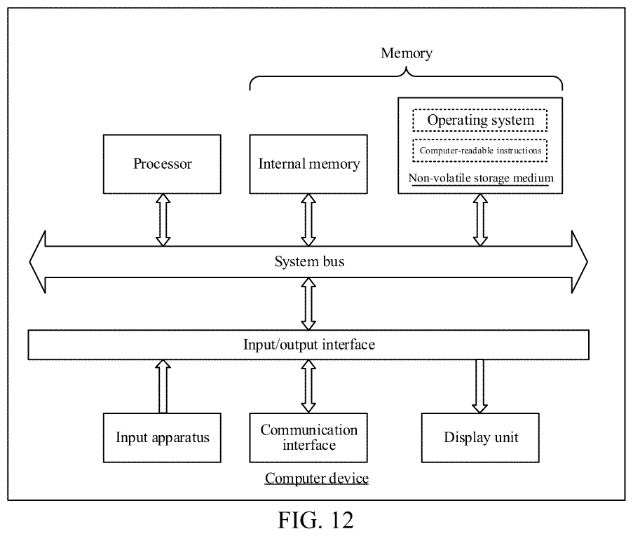

In some embodiments, a computer device is provided. The computer device may be a terminal, and an internal structural diagram thereof may be as shown in FIG. 12. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control abilities. The memory of the computer device includes a non-volatile storage medium and an internal memory. The non-volatile storage medium stores an operating system and computer-readable instructions. The internal memory provides an environment for the operation of the operating system and the computer-readable instructions in the non-volatile storage medium. The input/output interface of the computer device is configured to exchange information between the processor and external devices. The communication interface of the computer device is configured to communicate with external terminals in a wired or wireless way. The wireless way may be achieved through WIFI, mobile cellular networks, Near Field Communication (NFC), or other technologies. The computer-readable instructions are executed by the processor to implement a data caching method. The display unit of the computer device is configured to form a visually visible image, which may be a display screen, a projection apparatus, or a virtual reality imaging apparatus. The display screen may be a liquid crystal display screen or an electronic ink display screen. The input apparatus of the computer device may be a touch layer covering the display screen, may be buttons, a trackball, or a touch pad provided on the housing of the computer device, or may be an external keyboard, touch pad, or mouse.

A person skilled in the art may understand that the structures shown in FIG. 11 and FIG. 12 are only block diagrams of partial structure related to a solution and do not constitute a limitation to the computer device to which the solution in some embodiments is applied. The computer device may include more or fewer components than those shown therein, or some components may be combined, or a different component deployment may be adopted.

In some embodiments, a computer device is further provided. The computer device includes a memory and a processor. The memory has computer-readable instructions stored therein. The computer-readable instructions, when executed by the processor, implement operations in each method embodiment described above. The computer device may be a terminal or a network collaboration node.

In some embodiments, a computer-readable storage medium is provided, which has computer-readable instructions stored therein. The computer-readable instructions, when executed by a processor, implement operations in each method embodiment described above.

In some embodiments, a computer program product is provided, which includes computer-readable instructions. The computer-readable instructions, when executed by a processor, implement operations in each method embodiment described above.

The network configuration information (including but not limited to the IP address and the port number) and data (including but not limited to data for analysis, stored data, and displayed data) involved in some embodiments are all authorized by the objects or fully authorized by all parties, and the collection, use, and processing of relevant data should comply with relevant laws, regulations, and standards of relevant countries and regions.

A person of ordinary skill in the art may understand that all or some of the processes for implementing the method according to some embodiments above may be implemented through computer-readable instructions by instructing relevant hardware. The computer-readable instructions may be stored in a non-volatile computer-readable storage medium. When the computer-readable instructions are executed, the processes of the method according to some embodiments above may be implemented. Any reference to the memory, the database, or other media used in some embodiments may include at least one of non-volatile and volatile memories. The non-volatile memory may include a Read Only Memory (ROM), a magnetic tape, floppy disk, a flash memory, an optical memory, a high-density embedded non-volatile memory, a Resistive Random Access Memory (ReRAM), a Magnetoresistive Random Access Memory (MRAM), a Ferroelectric Random Access Memory (FRAM), a Phase Change Memory (PCM), a graphene memory, and the like. The volatile memory may include a Random Access Memory (RAM) or an external cache memory. As an explanation rather than limitation, the RAM may be in various forms, such as Static Random Access Memory (SRAM) or Dynamic Random Access Memory (DRAM). The databases involved in the various some embodiments may include at least one of a relational database and a non-relational database. The non-relational database may include a blockchain-based distributed database or the like, which is not limited here. The processor involved in the various some embodiments may be a central processing unit (CPU), a graphics processing unit (GPU), a digital signal processor, a programmable logic unit, a quantum computing-based data processing logic unit or the like. However, the disclosure is not limited thereto.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data caching method, executed by a terminal, comprising:
acquiring a detection result for a device performance index of the terminal;
analyzing the detection result to determine whether the detection result satisfies a preset condition for initiating collaborative caching;
determining, based on the detection result satisfying the preset condition, a network collaboration node through which data transmitted between the terminal and a server is to pass, and generating a collaborative caching request indicating the network collaboration node is to cache target traffic data, wherein the target traffic data comprises traffic data transmitted by the server to the terminal that is indicated in the collaborative caching request;
transmitting the collaborative caching request to the network collaboration node;
transmitting, based on a network data caching capacity of the terminal satisfying a preset storage condition, a data acquisition request to the network collaboration node; and
receiving cached target traffic data transmitted by the network collaboration node in response to the data acquisition request.

2. The data caching method according to claim 1, wherein the device performance index comprises at least one of: a processor utilization rate or a remaining internal memory capacity,
wherein the analyzing the detection result comprises determining whether the detection result satisfies the preset condition based on at least one of: a first preset condition being satisfied or a second preset condition being satisfied,
wherein the first preset condition comprises a first preset relationship being maintained between a first detection result for the processor utilization rate and a first preset utilization rate threshold for a first duration exceeding a first duration threshold, and
wherein the second preset condition comprises a second preset relationship being maintained between a second detection result for the remaining internal memory capacity and a first preset internal memory capacity threshold for a second duration exceeding a second duration threshold.

3. The data caching method according to claim 1, wherein the generating the collaborative caching request comprises:
determining a collaborative caching type based on the detection result; and
generating the collaborative caching request based on the collaborative caching type.

4. The data caching method according to claim 3, wherein the generating the collaborative caching request based on the collaborative caching type comprises generating, based on the collaborative caching type being full traffic caching, the collaborative caching request based on a first collaborative caching type field value corresponding to the full traffic caching and first network configuration information of the terminal.

5. The data caching method according to claim 4, further comprising:
determining, based on detecting the network data caching capacity satisfies the preset storage condition, a first data volume of first traffic data to be acquired based on the network data caching capacity;
generating the data acquisition request based on the first network configuration information and the first data volume;
transmitting the data acquisition request to the network collaboration node, wherein the data acquisition request instructs the network collaboration node to parse the data acquisition request to obtain second network configuration information and a second data volume, search for a data caching queue, in the data acquisition request, corresponding to the second network configuration information, and extract second traffic data from the data caching queue that matches the second data volume; and
receiving the second traffic data from the network collaboration node.

6. The data caching method according to claim 4, further comprising:
generating, based on detecting the device performance index of the terminal satisfies a condition for canceling collaborative caching, a collaboration cancellation request based on a second collaborative caching type field value corresponding to collaborative caching cancellation and the first network configuration information, wherein the collaboration cancellation request instructs the network collaboration node to parse the collaboration cancellation request to obtain second network configuration information, and delete a data caching queue corresponding to the second network configuration information;
transmitting the collaboration cancellation request to the network collaboration node; and
receiving a collaborative caching cancellation message transmitted by the network collaboration node.

7. The data caching method according to claim 3, wherein the generating the collaborative caching request based on the collaborative caching type comprises:
acquiring, based on the collaborative caching type being partial traffic caching, a traffic identifier for media data under processing by the terminal; and
generating the collaborative caching request based on a first collaborative caching type field value corresponding to the partial traffic caching, the traffic identifier, and first network configuration information of the terminal.

8. The data caching method according to claim 7, wherein the acquiring the traffic identifier for the media data comprises:
acquiring the first network configuration information, second network configuration information of the server, and a network protocol for communication between the terminal and the server;
concatenating the first network configuration information of the terminal, the second network configuration information of the server, and the network protocol to obtain a concatenation result; and
obtaining an encrypted result by encrypting the concatenation result, and using the encrypted result as the traffic identifier for the media data under processing by the terminal.

9. The data caching method according to claim 7, wherein the acquiring the traffic identifier for the media data comprises using, as the traffic identifier, a connection identifier determined through negotiation between the terminal and the server for transmitting the media data.

10. The data caching method according to claim 7, further comprising:
determining, based on detecting the network data caching capacity satisfies the preset storage condition, a first data volume of first traffic data to be acquired based on the network data caching capacity;
generating the data acquisition request based on the traffic identifier and the first data volume;
transmitting the data acquisition request to the network collaboration node, wherein the data acquisition request instructs the network collaboration node to parse the data acquisition request to obtain a second traffic identifier and a second data volume, search for a data caching queue, in the data acquisition request, corresponding to the second traffic identifier, and extract second traffic data, from the data caching queue, that matches the second data volume; and
receiving the second traffic data from the network collaboration node.

11. A data caching apparatus, comprising:
at least one memory configured to store computer program code; and
at least one processor configured to read the program code and operate as instructed by the program code, the program code comprising:
first detection code configured to cause at least one of the at least one processor to:
acquire a detection result for a device performance index of a terminal; and
analyze the detection result to determine whether the detection result satisfies a preset condition for initiating collaborative caching; and
first generating code configured to cause at least one of the at least one processor to determine, based on the detection result satisfying the preset condition, a network collaboration node through which data transmitted between the terminal and a server is to pass, and generate a collaborative caching request indicating the network collaboration node is to cache target traffic data, wherein the target traffic data comprises traffic data transmitted by the server to the terminal that is indicated in the collaborative caching request;
first transmitting code configured to cause at least one of the at least one processor to transmit the collaborative caching request to the network collaboration node;
second transmitting code configured to cause at least one of the at least one processor to transmit, based on a network data caching capacity of the terminal satisfying a preset storage condition, a data acquisition request to the network collaboration node; and
first receiving code configured to cause at least one of the at least one processor to receive cached target traffic data transmitted by the network collaboration node in response to the data acquisition request.

12. The data caching apparatus according to claim 11, wherein the device performance index comprises at least one of: a processor utilization rate or a remaining internal memory capacity,
wherein the first detection code is configured to cause at least one of the at least one processor to determine whether the detection result satisfies the preset condition based on at least one of: a first preset condition being satisfied or a second preset condition being satisfied,
wherein the first preset condition comprises a first preset relationship being maintained between a first detection result for the processor utilization rate and a first preset utilization rate threshold for a first duration exceeding a first duration threshold, and
wherein the second preset condition comprises a second preset relationship being maintained between a second detection result for the remaining internal memory capacity and a first preset internal memory capacity threshold for a second duration exceeding a second duration threshold.

13. The data caching apparatus according to claim 11, wherein the first generating code is configured to cause at least one of the at least one processor to:
determine a collaborative caching type based on the detection result; and
generate the collaborative caching request based on the collaborative caching type.

14. The data caching apparatus according to claim 13, wherein the first generating code is configured to cause at least one of the at least one processor to generate, based on the collaborative caching type being full traffic caching, the collaborative caching request based on a first collaborative caching type field value corresponding to the full traffic caching and first network configuration information of the terminal.

15. The data caching apparatus according to claim 14, wherein the program code further comprises:
second detection code configured to cause at least one of the at least one processor to determine, based on detecting the network data caching capacity satisfies the preset storage condition, a first data volume of first traffic data to be acquired based on the network data caching capacity;
second generating code configured to cause at least one of the at least one processor to generate the data acquisition request based on the first network configuration information and the first data volume;
third transmitting code configured to cause at least one of the at least one processor to transmit the data acquisition request to the network collaboration node, wherein the data acquisition request instructs the network collaboration node to parse the data acquisition request to obtain second network configuration information and a second data volume, search for a data caching queue, in the data acquisition request, corresponding to the second network configuration information, and extract second traffic data from the data caching queue that matches the second data volume; and
second receiving code configured to cause at least one of the at least one processor to receive the second traffic data from the network collaboration node.

16. The data caching apparatus according to claim 14, wherein the program code further comprises:
second generating code configured to cause at least one of the at least one processor to generate, based on detecting the device performance index of the terminal satisfies a condition for canceling collaborative caching, a collaboration cancellation request based on a second collaborative caching type field value corresponding to collaborative caching cancellation and the first network configuration information, wherein the collaboration cancellation request instructs the network collaboration node to parse the collaboration cancellation request to obtain second network configuration information, and delete a data caching queue corresponding to the second network configuration information;
third transmitting code configured to cause at least one of the at least one processor to transmit the collaboration cancellation request to the network collaboration node; and
second receiving code configured to cause at least one of the at least one processor to receive a collaborative caching cancellation message transmitted by the network collaboration node.

17. The data caching apparatus according to claim 13, wherein the program code further comprises second generating code configured to cause at least one of the at least one processor to:
acquire, based on the collaborative caching type being partial traffic caching, a traffic identifier for media data under processing by the terminal; and
generate the collaborative caching request based on a first collaborative caching type field value corresponding to the partial traffic caching, the traffic identifier, and first network configuration information of the terminal.

18. The data caching apparatus according to claim 17, wherein the second generating code is configured to cause at least one of the at least one processor to:
acquire the first network configuration information, second network configuration information of the server, and a network protocol for communication between the terminal and the server;
concatenate the first network configuration information of the terminal, the second network configuration information of the server, and the network protocol to obtain a concatenation result; and
obtain an encrypted result by encrypting the concatenation result, and using the encrypted result as the traffic identifier for the media data under processing by the terminal.

19. The data caching apparatus according to claim 17, wherein the second generating code is configured to cause at least one of the at least one processor to use, as the traffic identifier, a connection identifier determined through negotiation between the terminal and the server for transmitting the media data.

20. A non-transitory computer-readable storage medium, storing computer code which, when executed by at least one processor, causes the at least one processor to at least:
acquire a detection result for a device performance index of a terminal;
analyze the detection result to determine whether the detection result satisfies a preset condition for initiating collaborative caching;
determine, based on the detection result satisfying the preset condition, a network collaboration node through which data transmitted between the terminal and a server is to pass, and generate a collaborative caching request indicating the network collaboration node is to cache target traffic data, wherein the target traffic data comprises traffic data transmitted by the server to the terminal that is indicated in the collaborative caching request;
transmit the collaborative caching request to the network collaboration node;
transmit, based on a network data caching capacity of the terminal satisfying a preset storage condition, a data acquisition request to the network collaboration node; and
receive cached target traffic data transmitted by the network collaboration node in response to the data acquisition request.
